(19) United States
(12) Patent Application Publication
(10) Pub. No.: US 2011/0032180 A1
(43) Pub. Date: Feb. 10, 2011

(54) DISPLAY DEVICE, METHOD OF MANUFACTURING DISPLAY DEVICE AND ELECTRONIC APPARATUS

(75) Inventors: Takeo KAWASE, Suwa (JP); Harunobu KOMATSU, Suwa (JP); Hitoshi YAMAMOTO, Suwa (JP); Akira MATSUMOTO, Suwa (JP); Mitsuo KUSHINO, Suita (JP); Tomoyuki KUWAMOTO, Suita (JP); Teruki MATSUSHITA, Suita (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/535,050

(22) Filed: Aug. 4, 2009

(51) Int. Cl. G09G 3/34; B32B 38/08

(52) U.S. Cl. 345/107; 156/281

(57) ABSTRACT

A display device is equipped with a laminate portion of a plurality of laminated adsorption particle-containing layers including a first adsorption particle-containing layer having a wall portion defining a space and electrically charged adsorption particles adsorbed to an inner surface of the wall portion, and a second adsorption particle-containing layer including a wall portion defining a space and electrically charged adsorption particles adsorbed to an inner surface of the wall portion and having a hue different from that of the adsorption particles of the first adsorption particle-containing layer: and one or more pairs of electrodes that, when applied with an electrical voltage, generate electric fields to act on the adsorption particles, and characterized in that, upon application of an electrical voltage across the one or more pairs of electrodes, the adsorption particles of each of the absorption particle-containing layers are moved, while being adsorbed to the inner surface of the wall portion, along the inner surface.

The entire disclosure of Japanese Patent Application No. 2008-095471, filed Aug. 4, 2009 is expressly incorporated by reference herein.

### BACKGROUND OF THE INVENTION

1. Field of Invention

The present invention relates to display devices, methods of manufacturing display devices and electronic apparatuses.

2. Background of Technology

It is generally known that, when an electric field is applied to a dispersal system in which fine particles are dispersed in a liquid, the fine particles move (swim) in the liquid by a Coulomb force (an electrostatic force). This phenomenon is called electrophoresis. In recent years, electrophoretic display devices that display desired information (images) using the electrophoresis draw attention as novel display devices.

This display device is equipped with a display memory property to maintain a displayed content even in a state where application of voltage is stopped, such that its power consumption is low. Also, in particular, because it uses reflected light for display, like ordinary printed matters, it is characterized in that it has a wide viewing angle and an ability of high-contrast display.

As a conventional electrophoretic display device, Patent Document 1 describes an electrophoretic display device that uses an electrophoretic dispersing liquid in which two kinds of electrophoretic particles mutually charged with opposite polarities are dispersed in a liquid phase dispersion medium. Also, Patent Document 2 describes an electrophoretic display device that uses microcapsules encapsulating in shells an electrophoretic dispersing liquid in which one kind of electrophoretic particles is dispersed in a liquid phase dispersing medium. Further, there has also been proposed an electrophoretic display device that combines the foregoing Patent Document 1 and Patent Document 2, namely, a device that uses microcapsules encapsulating in shells an electrophoretic dispersion liquid in which electrophoretic particles for white color display (white particles) and electrophoretic particles for black color display (black particles), being mutually charged with opposite polarities, are dispersed in a liquid phase dispersing medium.

According to these systems, which may be called conventional electrophoretic systems, the particles move to an opposite polarity side of the surface charge polarity of the micro particles upon application of an electric field, in parallel with a direction of the application of the electric field.

Electrophoretic display devices according to the conventional system can relatively readily perform switching and displaying predetermined two colors, such as, displaying white and black, but entailed variety of problems when there are three or more colors.

[Patent Document 1] U.S. Pat. No. 800963

[Patent Document 2] JP. Pat. No. 2551783

It is an object of the present invention to provide a display device that is capable of readily and reliably displaying multiple colors, and is capable of reliably maintaining each of the colors even in a state in which application of voltage is stopped, a method for manufacturing a display device capable of readily and reliably manufacturing such a display device, and an electronic apparatus.

### SUMMARY OF THE INVENTION

As a result of keen examination, we have found a method (an electro-crawling method) by which fine particles move in a crawling manner along the inner wall of the retention wall or the capsule, as distinguished from the conventional electrophoresis method.

This phenomenon occurs if the absolute value of the net charge amount of the inner wall of the retention wall or the capsule is greater than the absolute value of the net charge amount of the surface of each of the fine particles, and the charge polarities thereof are opposite to each other. The electro-crawling method will be described later in greater detail.

Such objects described above can be accomplished by the following aspects of the present invention.

A display device in accordance with the present invention is equipped with a laminate portion of a plurality of laminated adsorption particle-containing layers including a first adsorption particle-containing layer having a wall portion defining a space and electrically charged adsorption particles adsorbed to an inner surface of the wall portion, and a second adsorption particle-containing layer including a wall portion defining a space and electrically charged adsorption particles adsorbed to an inner surface of the wall portion and having a hue different from that of the adsorption particles of the first adsorption particle-containing layer; and

one or more pairs of electrodes that, when applied with an electrical voltage, generate electric fields to act on the adsorption particles,

and characterized in being structured such that, upon application of a voltage between the one or more pairs of electrodes, the adsorption particles of each of the absorption particle-containing layers are moved, while being adsorbed to an inner surface of the wall portion, along the inner surface.

By this, a plurality of colors (multiple colors) can be readily and reliably displayed. In particular, this ensures that the adsorption particles (display particles) are always adsorbed to any region on the inner surface of the wall portion (e.g., a shell of a microcapsule), such that each of the colors can be readily and reliably obtained, and each of the colors can be reliably maintained even in a state in which the voltage application is stopped. In other words, display becomes substantially stable and, even when the voltage application is stopped after a specified display content (an image) has been displayed, its display content can be stably maintained (namely, it is possible to prevent a display state from being deteriorated).

Also, since the adsorption particles are adsorbed to the inner surface of the wall portion so that they are hard to adhere to other members, whereby display contrast is increased and chromatic purity is improved.

Furthermore, it is possible to reliably move the adsorption particles with relatively weak electric fields, whereby power consumption can be reduced.

In the display device according to the present invention, it is preferred that the adsorption particles are adsorbed to the inner surface of the wall portion due to an electrostatic force.

By this, the adsorption particles can be readily and reliably adsorbed to the inner surface of the wall portion.

In the display device according to the present invention, the pair of electrodes may preferably be provided on each of the first absorption particle-containing layer and the second absorption particle-containing layer.

This makes possible to obtain each of the colors more reliably.

In the display device according to the present invention, it is preferred that the pair of electrodes are provided opposite to each other through the corresponding one of the adsorption particle-containing layers, and the inner surface of the wall portion has a curved concave surface extending between the pair of electrodes.

This makes it possible for the adsorption particles to smoothly and reliably move along the inner surface of the wall portion, and therefore, it is possible to obtain each of the colors more readily and reliably.

In the display device according to the present invention, the electrode between the first absorption particle-containing layer and the second absorption particle-containing layer may preferably be common to the first absorption particle-containing layer and the second absorption particle-containing layer.

This makes it possible to thinner the device.

In the display device according to the present invention, it is preferred that the adsorption particles and the wall portion are charged with mutually opposite polarities, whereby the adsorption particles remain adsorbed to the inner surface of the wall portion.

This ensures that the adsorption particles can be more readily and reliably adsorbed to the inner surface of the wall portion.

In the display device according to the present invention, it is preferred that an attractive force due to an interaction between the adsorption particles and the wall portion including the electrostatic force therebetween is greater than an electrostatic force acting on the adsorption particles due to the electric fields generated between the pair of electrodes.

This ensures that the adsorption particles are more reliably moved, while being adsorbed to the inner surface of the wall portion, along the inner surface of the wall portion.

In the display device according to the present invention, it is preferred that the wall portion is formed from a shell body defining the space in a spherical shape or an ellipsoidal shape, and a microcapsule is formed by encapsulating the adsorption particles in the shell body.

This makes it possible for the adsorption particles to smoothly and reliably move along the inner surface of the wall portion (the shell body), whereby each of the colors can be more readily and reliably obtained.

Also, the display device can be manufactured more readily and reliably than a so-called microcup type display device.

In the display device according to the present invention, it is preferred that the shell body has a first layer and a second layer disposed outside the first layer, which are both in a shell-like shape.

By this, the display device can be readily manufactured.

In the display device according to the present invention, it is preferred that the first absorption particle-containing layer among the absorption particle-containing layers is located remotest from a display surface, and the first absorption particle-containing layer has a scattering body disposed in the space for scattering light.

This makes it possible to provide white color display, and display other colors more sharply.

In the display device according to the present invention, it is preferred that the scattering body is a liquid filled in the space.

This makes it possible to obtain more excellent display characteristics.

In the display device according to the present invention, it is preferred that the liquid is made of a liquid phase dispersant medium and dispersing particles dispersed therein.

This makes it possible to obtain more excellent display characteristics.

In the display device according to the present invention, it is preferred that the dispersing particles are particles capable of scattering light.

This makes it possible to obtain more excellent display characteristics.

In the display device according to the present invention, it is preferred that the scattering body is a structure that is provided in the space; in a manner to be spaced a predetermined distance from the inner surface of the wall portion, and

the adsorption particles are positioned between the wall portion and the structure.

This makes it possible to obtain more excellent display characteristics.

In the display device according to the present invention, it is preferred that the first absorption particle-containing layer among the absorption particle-containing layers is located remotest from the display surface, and the first absorption particle-containing layer has a colored body disposed in the space and having a hue different from that of the adsorption particles.

This makes it possible to display more colors without increasing the number of layers of the absorption particle-containing layers.

In the display device according to the present invention, it is preferred that the colored body is a liquid filled in the space.

This makes it possible to obtain more excellent display characteristics.

In the display device according to the present invention, it is preferred that the liquid is made of a liquid phase dispersant medium and dispersing particles dispersed therein.

This makes it possible to obtain more excellent display characteristics.

In the display device according to the present invention, it is preferred that the dispersing particles are colored particles.

This makes it possible to obtain more excellent display characteristics.

In the display device according to the present invention, it is preferred that the colored body is a structure that is provided in the space, in a manner to be spaced a predetermined distance from the inner surface of the wall portion, and

the adsorption particles are positioned between the wall portion and the structure.

This makes it possible to obtain more excellent display characteristics.

In the display device according to the present invention, it is preferred that the dispersing particles are substantially not charged, or charged with a polarity opposite to that of the adsorption particles.

This makes it possible to prevent the dispersing particles from being adsorbed to the inner surface of the wall portion, even when the wall portion is charged with a polarity opposite to that of the adsorption particles.

In the display device according to the present invention, it is preferred that the first absorption particle-containing layer among the absorption particle-containing layers is positioned remotest from a display surface, and the display device includes a reflector that diffusely reflects light to an opposite side of the display surface.

This makes it possible to provide white color display, and display other colors more sharply.

In the display device according to the present invention, it is preferred that the reflector includes particles capable of scattering light filled in a gap.

This makes it possible to improve efficiency with which incident light is used.

A method of manufacturing a display device according to the present invention comprises: a first microcapsule-containing layer formation step for producing microcapsules each encapsulating electrically charged adsorption particles in a shell, and forming a first microcapsule-containing layer containing the microcapsules:

a second microcapsule-containing layer formation step for producing microcapsules each encapsulating in a shell electrically charged adsorption particles having a hue different from that of the adsorption particles in the first microcapsule-containing layer, and forming a second microcapsule-containing layer containing the microcapsules; and

a lamination step for laminating the first microcapsule-containing layer and the second microcapsule-containing layer,

wherein each of the first microcapsule-containing layer formation step and the second microcapsule-containing layer formation step comprises a charging step for electrically charging the shell with an opposite polarity to the adsorption particles after forming a portion or the entirety of the inner surface side of the shell, whereby the adsorption particles are adsorbed to the inner surface of the shell by the charging step.

This makes it possible to manufacture the display device according to the present invention readily and reliably.

In the method according to the present invention, it is preferred that the shell comprises a first layer and a second layer arranged outside the first layer, each having a shell-like shape, and the charging step is performed when forming the second layer.

Accordingly, the display device according to the present invention can be readily and reliably manufactured.

In the method according to the present invention, it is preferred that, after the shell has been formed, the charging step is performed through a fixing material that makes close contact with the outer surface of each of the microcapsules to fix the microcapsules in place.

This makes it possible to manufacture the display device according to the present invention readily and reliably.

An electronic apparatus in accordance with the present invention is characterized in having the display device according to the present invention.

This makes it possible to provide an electronic apparatus having excellent display characteristics.

### BRIEF DESCRIPTION OF THE DRAWINGS

FIG. 1 is a vertical cross-sectional view schematically showing a first embodiment of a display device according to the present invention.

FIGS. 2 are schematic diagrams for explaining behavior of the display device shown in FIG. 1.

FIG. 3 is a schematic diagram for explaining behavior of the display device shown in FIG. 1.

FIG. 4 is a graph (a potential curve) showing a relationship of a distance between a surface of each of adsorption particles and an inner surface of a capsule body to potential of the adsorption particle in the display device shown in FIG. 1.

FIG. 5 is a schematic diagram for explaining behavior of the display device shown in FIG. 1.

FIGS. 6 are schematic diagrams of microcapsules of a first microcapsule-containing layer for explaining behavior of the display device shown in FIG. 1.

FIG. 7 is a schematic diagram for explaining behavior of the display device shown in FIG. 1.

FIGS. 8 are schematic diagrams for explaining a method of manufacturing the display device shown in FIG. 1.

FIGS. 9 are schematic diagrams for explaining a method of manufacturing the display device shown in FIG. 1.

FIGS. 10 are schematic diagrams for explaining a method of manufacturing the display device shown in FIG. 1.

FIG. 11 is a vertical cross-sectional view schematically showing a microcapsule of a first microcapsule-containing layer according to a third embodiment of the display device of the invention.

FIG. 12 is a vertical cross-sectional view schematically showing a fourth embodiment of a display device according to the present invention.

FIG. 13 is a perspective view showing an embodiment in which an electronic apparatus according to the present invention is used in an electronic paper.

FIGS. 14 are views showing an embodiment in which an electronic apparatus according to the present invention is used in a display apparatus.

### PREFERRED EMBODIMENTS

Hereinafter, a display device, a method of manufacturing a display device and an electronic apparatus in accordance with the present invention shall be described in detail with reference to preferred embodiments shown in the accompanying drawings.

Here, a laminate portion of the display device according to the present invention is a laminate in which a plurality of adsorption particle-containing layers are laminated, and the number of layers of the adsorption particle-containing layers is not particularly limited to any value, if it is two or more. In the following embodiments, a case in which four microcapsule-containing layers (adsorption particle-containing layers) are laminated is described as a representative.

### First Embodiment

1. Display Device

First, the display device according to the present invention is described.

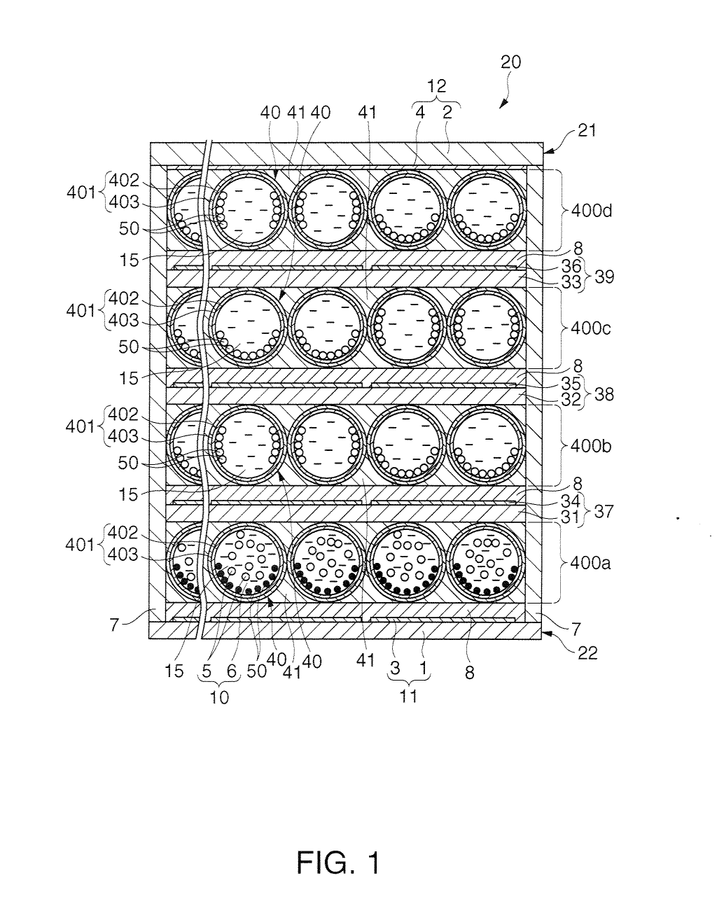

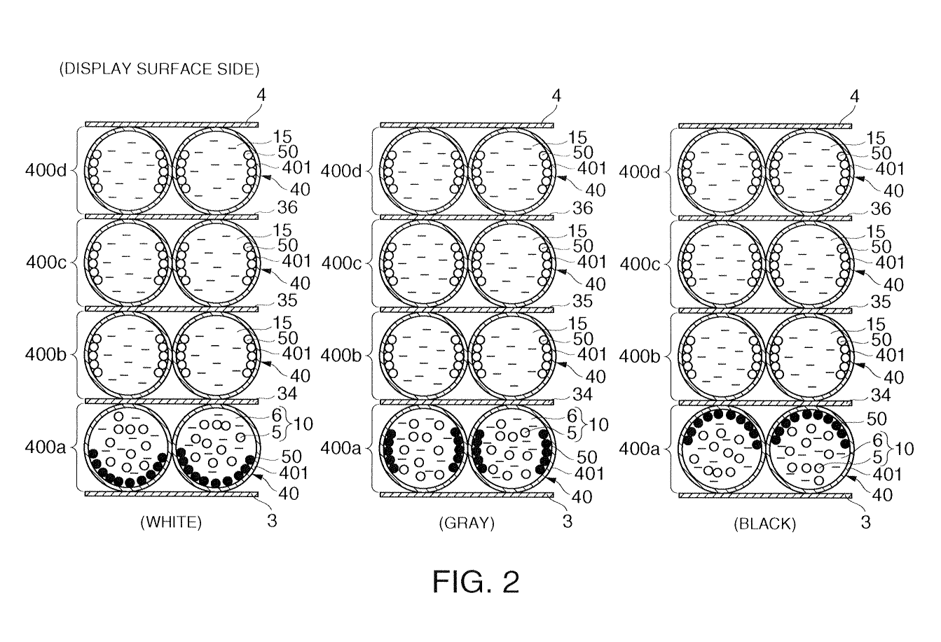

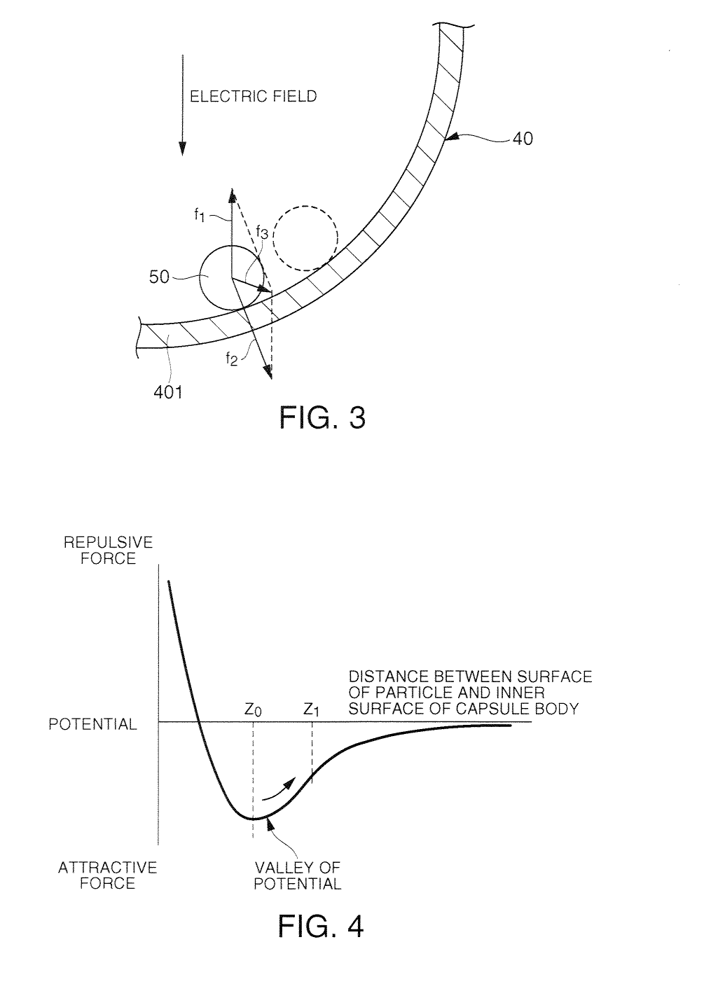

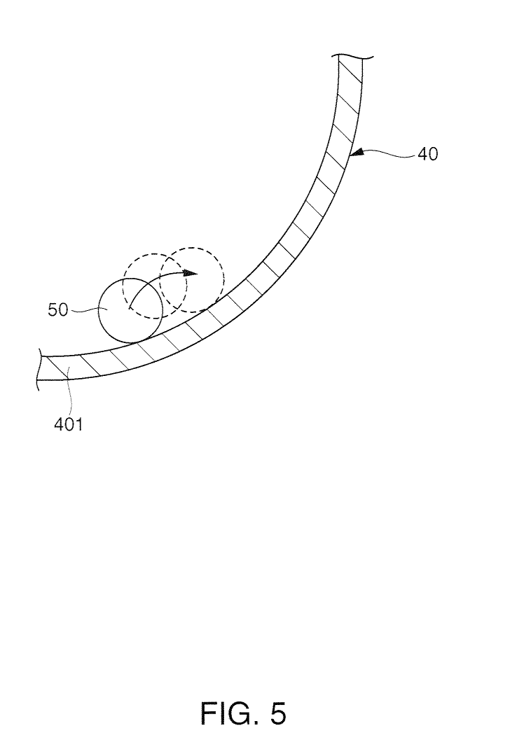

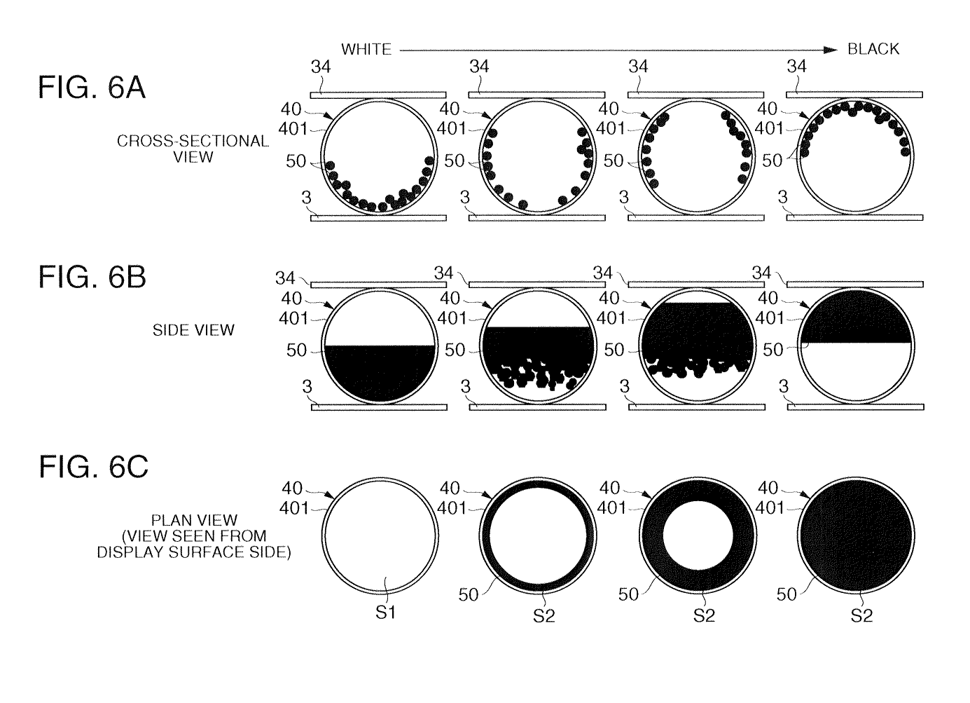

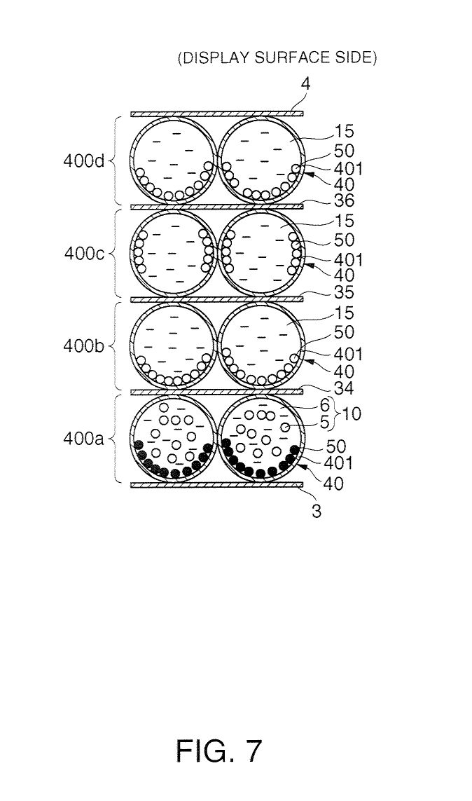

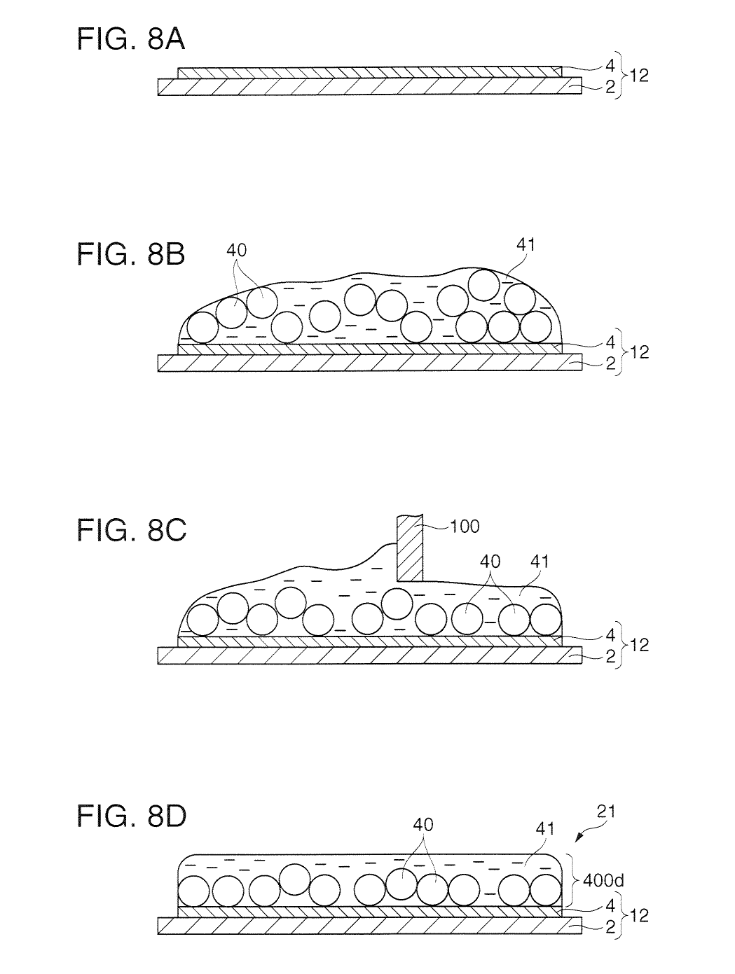

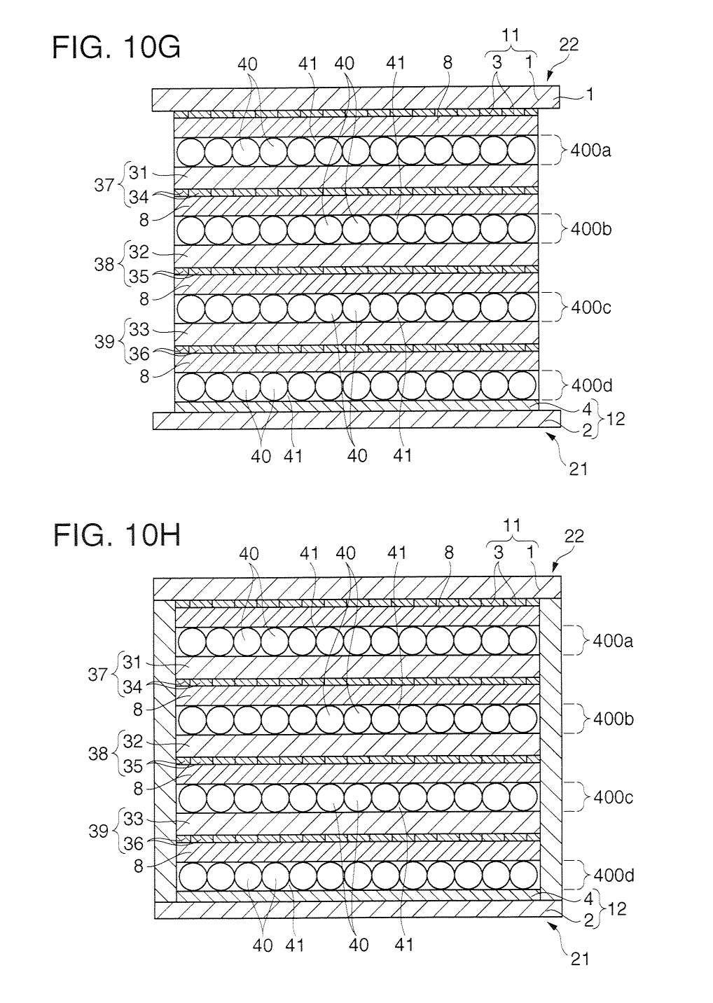

FIG. 1 is a vertical cross-sectional view schematically showing a first embodiment of the display device according to the present invention. FIGS. 2 and FIG. 3 are schematic diagrams for explaining behavior of the display device shown in FIG. 1. FIG. 4 is a graph (a potential curve) showing a relationship of a distance between a surface of each of adsorption particles and an inner surface of a capsule body to potential of the adsorption particle in the display device shown in FIG. 1, and FIG. 5 is a schematic diagram for explaining behavior of the display device shown in FIG. 1. FIGS. 6 are schematic diagrams of microcapsules of a first microcapsule-containing layer for explaining behavior of the display device shown in FIG. 1, wherein FIG. 6 (a) is a cross-sectional view, FIG. 6 (b) is a side view, and FIG. 6 (c) is a plan view (a view seen from the top surface side). Also, FIG. 7 is a schematic diagram for explaining behavior of the display device shown in FIG. 1. Also, FIGS. 8˜FIG. 10 are schematic diagrams for explaining a method of manufacturing the display device shown in FIG. 1.

It is noted that, hereinafter, description shall be made with the upper side in each of FIG. 1˜FIG. 3, FIG. 5, and FIG. 7˜FIGS. 10 being referred to as “upper” and the lower side being referred to as “lower” for the sake of convenience in description.

Further, with reference to each of FIGS. 2, FIG. 3, FIG. 5 and FIGS. 6, description of a capsule body 401 is simplified and presented as a single layer.

Also, in FIGS. 6, illustration of a liquid phase dispersion medium 6 and dispersing particles 5 and hatching lines indicating cross sections are omitted.

Further, in FIG. 6 (b) and FIG. 6 (c), to show an interior of the capsule body 401, the portion of the capsule body 401 is shown in a cross-sectional view.

As shown in FIG. 1, the display device 20 includes a display sheet (a front plane) 21, a circuit board (a back plane) 22, an adhesive agent layer 8 for bonding the display sheet 21 and the circuit board 22 together, and a sealing part 7 for air-tightly sealing a gap between the display sheet 21 and the circuit board 22. It is noted that the upper side in FIG. 1 corresponds to a display surface side, and the lower side corresponds to an opposite side to the display surface.

The display sheet 21 includes a laminate portion having a first microcapsule-containing layer (an adsorption particle-containing layer) 400a, a second microcapsule-containing layer (an adsorption particle-containing layer) 400b, a third microcapsule-containing layer (an adsorption particle-containing layer) 400c and a fourth microcapsule-containing layer (an adsorption particle-containing layer) 400d, laminated in this order. The first˜fourth microcapsule-containing layers 400a˜400d are each comprised of microcapsules 40 and a binder 41. Among the first˜fourth microcapsule-containing layers 400a˜400d, the first microcapsule-containing layer 400a is located at the lowermost portion (remotest from the display surface).

Also, the display sheet 21 includes a base substrate 37 equipped with a plate-like base portion 31 and a plurality of electrodes 34 formed on an upper surface of the base portion 31, a base substrate 38 equipped with a plate-like base portion 32 and a plurality of electrodes 35 formed on an upper surface of the base portion 32, a base substrate 39 equipped with a plate-like base portion 33 and a plurality of electrodes 35 formed on an upper surface of the base portion 33, and a base substrate 12 equipped with a plate-like base portion 2 and an electrode 4 provided on a lower surface of the base portion 2. Each of the base substrates 37˜39 (the base portions 31˜33) is provided with a circuit (not shown) including switching elements, such as, for example. TFTs and the like.

The base substrate 37 is located between the first microcapsule-containing layer 400a and the second microcapsule-containing layer 400b, the base substrate 38 is located between the second microcapsule-containing layer 400b and the third microcapsule-containing layer 400c, the base substrate 39 is located between the third microcapsule-containing layer 400c and the fourth microcapsule-containing layer 400d, and the base substrate 12 is located on the upper side of the fourth microcapsule-containing layer 400. The adhesive agent layers 8 are provided between the base substrate 37 and the second microcapsule-containing layer 400b, between the base substrate 38 and the third microcapsule-containing layer 400d, and between the base substrate 39 and the fourth microcapsule-containing layer 400d, respectively, and they are bonded by the adhesive agent layers 8.

On the other hand, the circuit board 22 includes a counter substrate 11 equipped with a plate-like base portion 1 and a plurality of electrodes 3 formed on an upper surface of the base portion 1, and a circuit (not shown) provided in the counter substrate 11 (on the base portion 1), which includes switching elements such as TFTs and the like.

A construction of the respective parts will be described one after another.

The base portions 1, 31˜33 and 2 are each formed from a sheet-like (plate-like) member, and the base portions 1 and 2 in particular have a function of supporting or protecting the respective members arranged therebetween.

Although each of the base portions 1, 31˜33 and 2 may be either flexible or rigid, it is preferred to have flexibility. Use of the base portions 1, 31˜33 and 2 having flexibility makes it possible to provide a flexible display device 20, in other words, a display device 20 useful in constructing, for example, an electronic paper.

In the case where each of the base portions (base material layers) 1, 31 33 and 2 is provided with flexibility, as a constituent material of each of them, for example, it is possible to use polyolefin such as polyethylene, modified polyolefin, polyamide, thermoplastic polyimide, polyether, polyether ether ketone, various kinds of polyurethane-based or chlorinated polyethylene-based thermoplastic elastomers, and copolymers, blends or polymer alloys mainly constituted of the above materials. One or more of these materials may be used independently or in combination.

An average thickness of each of the base portions 1, 31˜33 and 2 may be arbitrarily set depending on the constituent material and use thereof without any particular limitation. However, in the case where they are flexible, the average thickness thereof is preferably in the range of about 20 to 500 μm, and more preferably in the range of about 25 to 250 μm. This makes it possible to reduce the size (especially, the thickness) of the display device 20, while harmonizing flexibility and strength of the display device 20.

The electrodes 3 and 34˜36 and the electrode 4 each having a layered shape (a film shape) are respectively arranged on the upper surface of the base portions 1 and 31˜33 and the lower surface of the base portion 2. In other words, the electrodes 3 and the electrode 34 are provided in a mutually facing relationship through the first microcapsule-containing layer 400a, the electrode 34 and the electrode 35 are provided in a mutually facing relationship through the second microcapsule-containing layer 400b, the electrode 35 and the electrode 36 are provided in a mutually facing relationship through the third microcapsule-containing layer 400c, and the electrode 36 and the electrode 4 are provided in a mutually facing relationship through the fourth microcapsule-containing layer 400d.

The electrodes 3 and 34 form a pair of electrodes for the first microcapsule-containing layer 400a, the electrodes 34 and 35 form a pair of electrodes for the second microcapsule-containing layer 400b, the electrodes 35 and 36 form a pair of electrodes for the third microcapsule-containing layer 400c, and the electrodes 36 and 4 form a pair of electrodes for the fourth microcapsule-containing layer 400d. In this manner, in this embodiment, the electrode 34 between the first microcapsule-containing layer 400a and the second microcapsule-containing layer 400b is shared by the first microcapsule-containing layer 400a and the second microcapsule-containing layer 400b, the electrode 35 between the second microcapsule-containing layer 400b and the third microcapsule-containing layer 400c is shared by the second microcapsule-containing layer 400b and the third microcapsule-containing layer 400c, and the electrode 36 between the third microcapsule-containing layer 400c and the fourth microcapsule-containing layer 400d is shared by the third microcapsule-containing layer 400c and the fourth microcapsule-containing layer 400d.

When an electrical voltage is applied across the electrodes 3 and the electrode 34, electric fields are generated across them so that the electric fields act on adsorption particles (display particles) 50, which will be described below, present in the first microcapsule-containing layer 400a. It is noted that, when dispersing particles (display particles) 5 to be described below are electrically charged, the electric fields also act on the dispersing particles 5. Similarly, when an electrical voltage is applied across the electrodes 34 and the electrode 35, electric fields are generated between them so that the electric fields act on adsorption particles (display particles) 50 present in the second microcapsule-containing layer 400b. When an electrical voltage is applied across the electrodes 35 and the electrode 36, electric fields are generated between them so that the electric fields act on adsorption particles (display particles) 50 present in the third microcapsule-containing layer 400c. When an electrical voltage is applied across the electrodes 36 and the electrode 4, electric fields are generated between them so that the electric fields act on adsorption particles (display particles) 50 present in the fourth microcapsule-containing layer 400d.

In this embodiment, the electrode 4 serves as a common electrode and the electrodes 3 and 34˜36 function as individual electrodes divided in a matrix (pixel electrodes connected to the switching elements), and the positions of the electrodes 3 and 34˜36 coincide with one another, as viewed in a plan view (as viewed from the upper side in FIG. 1). A portion where the electrode 4 overlaps one of the electrodes 3 and 34˜36 constitutes a unit pixel.

Just like the electrodes 3 and 34˜36, the electrode 4 may be divided into a plurality portions.

Each of the electrodes 3, 34˜36 and 4 is not particularly limited to any specific constituent material as long as it is substantially conductive. For examples, a variety of conductive materials can be enumerated, including: a metallic material such as copper, aluminum or alloy containing these metals; a carbon-based material such as carbon black; an electronically conductive polymer material such as polyacetylene, polyfluorene or derivatives thereof; an ion-conductive polymer material produced by dispersing an ionic substance such as NaCl or Cu(CF₃SO₃)₂ in a matrix resin such as polyvinyl alcohol or polycarbonate; and a conductive oxide material such as indium oxide (IO): and the like. One or more of these materials may be used independently or in combination.

An average thickness of each of the electrodes 3, 34˜36 and 4 may be arbitrarily set depending on the constituent material and use thereof, without any particular limitation to a specific value, and is preferably in the range of about 0.05 to 10 μm, and more preferably in the range of about 0.05 to 5 μm.

The adhesive agent layers 8 provided between the base portions 31˜33 and 2 and the electrodes 34˜36 and 4, between the base substrate 37 and the second microcapsule-containing layer 400b, between the base substrate 38 and the third microcapsule-containing layer 400c, and between the base substrate 39 and the fourth microcapsule-containing layer 400d, are optically transparent, in other words, substantially transparent (clear and colorless, clear and colored, or translucent). This makes it possible to easily recognize, through visual observation, a status of the adsorption particles 50 and the dispersing particles 5 to be described below, i.e., information (images) displayed by the display device 20.

In the display sheet 21, the fourth microcapsule-containing layer 400d is provided in contact with a lower surface of the electrode 4, the third microcapsule-containing layer 400c is provided in contact with a lower surface of the base portion 33, the second microcapsule-containing layer 400b is provided in contact with a lower surface of the base portion 32, and the first microcapsule-containing layer 400a is provided in contact with a lower surface of the base portion 31.

The first microcapsule-containing layer 400a includes a plurality of microcapsules 40 and a binder (a fixing material) 41 for fixing (or holding) the microcapsules 40 in place, each of the microcapsules 40 having a capsule body (a shell) 401 encapsulating a dispersion liquid 10 and adsorption particles 50 to be described below therein.

Each of the second˜fourth microcapsule-containing layers 400b˜400d is formed with a plurality of microcapsules 40 and a binder (a fixing material) 41 for fixing (or holding) the microcapsules 40 in place, each of the microcapsules 40 having a capsule body (a shell) 401 encapsulating a liquid 15 and adsorption particles 50 to be described below therein.

Hereinafter, the first˜fourth microcapsule-containing layers 400a˜400d will be described. As their structures are similar to each other except the microcapsules 40, the first microcapsule-containing layer 400a will be described as their representative. Also, the microcapsules 40 will be described below in detail.

The binder 41 makes close contact with an outer surface of each of the microcapsules 40 and covers each of the microcapsules 40. Gaps (openings) formed between the microcapsules 40 are filled with the binder 41.

Namely, the binder 41 is provided for the purpose of, for example, bonding the counter substrate 11 and the base substrate 37 together, fixing the microcapsules 40 between the counter substrate 11 and the base substrate 37, assuring insulation between the electrodes 3 and the electrode 34, and generating strong electric fields by filling the gaps between the microcapsules 40 therewith. This makes it possible to further improve durability, reliability and display performance of the display device 20.

A resin material that exhibits high affinity with (coherency with) the respective electrodes 3 and 34 and the capsule bodies 401 (of the microcapsules 40) and has excellent insulation performance and relatively high permittivity (which does not allow a current to flow at all or allows a current to slightly flow) may preferably be used as the binder 41.

As the binder 41, for example, various resin materials can be enumerated, including a thermoplastic resin, such as, polyethylene, polypropylene. ABS resin, ester methacrylate resin, methyl methacrylate resin, vinyl chloride resin or cellulose-based resin; silicone-based resin; urethane-based resin; and the like. One or more of these materials may be used independently or in combination.

In this embodiment, the display sheet 21 and the circuit board 22 are bonded together by means of the adhesive agent layer 8. By this, the display sheet 21 and the circuit board 22 can be more reliably fixed together.

It is preferred that the adhesive agent layer 8 is mainly constituted of polyurethane.

The polyurethane contains an isocyanate component, such as, for example, at least one kind of tetramethylxylene diisocyanate (TMXDI), hexamethylene diisocyanate (HMDI) and derivatives thereof, and a polyol component, such as, for example, at least one kind of polypropylene glycol (PPG), polytetramethylene glycol (PTMG) and derivatives thereof.

The constituent material of the adhesive agent layer 8 is not limited to the polyurethane. In addition, various resin materials, such as, for example, polyethylene, chlorinated polyethylene. ABS resin, vinyl acrylate copolymer, fluorine-based resin or silicone-based resin, and the like can be enumerated. One or more of these materials may be used independently or in combination.

The sealing part 7 is provided between the base portion 1 and the base portion 2, and along peripheral edges thereof. The electrodes 3, 34˜36 and 4, the first˜fourth microcapsule-containing layers 400a˜400d, and the adhesive agent layers 8 are air-tightly sealed by the sealing part 7. This makes it possible to prevent moisture from penetrating the display device 20, whereby deterioration of displayer performance of the display device 20 can be more securely prevented.

As a constituent material of the sealing part 7, various kinds of resin materials can be enumerated, including, for example, a thermoplastic resin such as acryl-based resin, urethane-based resin or olefin-based resin; a thermosetting resin such as epoxy-based resin, melamine-based resin or phenol-based resin; and the like. One or more of these resin materials may be used independently or in combination.

It is noted that the sealing part 7 may be either provided or removed depending on the necessity.

Next, the microcapsules 40 will be described, and the microcapsules 40 of the first microcapsule-containing layer 400a will be described as a representative.

The adsorption particles (electrically charged particles) 50 are adsorbed to an inner surface of the capsule body 401 of each of the microcapsules 40. In other words, the adsorption particles 50 are electrically charged with a specified polarity and the capsule body 401 is electrically charged with an opposite polarity to the adsorption particles 50 as will be described later, such that the adsorption particles 50 are adsorbed to the inner surface of the capsule body 401.

The adsorption particles 50 may include one or more kinds of particles, and particles that are colored (colored particles) may preferably be used. In this embodiment, black particles (colored particles) for displaying a black color are used as the adsorption particles 50.

Also, a liquid, i.e., a dispersing liquid 10 according to the present embodiment, is encapsulated (filled) in the capsule body 401, as a scattering body for scattering light or a colored substance having a hue different from that of the adsorption particles 50.

The dispersing liquid 10 is comprised of a liquid-phase dispersion medium 6 and dispersion particles 5 dispersed (suspended) therein. The dispersion particles 5 may include one or more kinds of particles, and may use particles that scatter light, or colored particles having a different hue to the adsorption particles 50. In the present embodiment, as the dispersion particles 5, particles that scatter light (so-called white particles for displaying white) are used. Namely, in the present embodiment, used as the dispersion liquid 10 is comprised of the liquid-phase dispersion medium 6 and the dispersion particles 5 that scatter light dispersed therein is used. It is noted that white color is displayed due to scattering of light.

It is noted that, instead of the dispersion liquid 10, a liquid that scatters light or has a hue different from that of the adsorption particles 50 without containing particles may be used. Further, for example, a gas that scatters light or has a hue different from that of the adsorption particles 50 may be used.

Here, the dispersion particles 5 may be charged or may not be charged. When they are charged, they need to be charged with an opposite polarity to the adsorption particles 50, in other words, need to be charge with the same polarity as the capsule body 40. This makes it possible to prevent the dispersion particles 5 from adsorbing to the inner surface of the capsule body 401.

Further, when the dispersion particles 5 are not substantially charged, the dispersion particles 5 and the adsorption particles 50 can be prevented from being adsorbed to one another.

Also, when the dispersion particles 5 are charged with an opposite polarity to the adsorption particles 50, the dispersion particles 5 and the adsorption particles 50 can be prevented from being adsorbed to one another by, for example, setting a charge amount (electrical charge amount), charge density and the like of the respective parts, so that a repelling force between the dispersion particles 5 and the capsule body 401 becomes greater than an attractive force between the dispersion particles 5 and the adsorption particles 50. The repelling force can be obtained by covering surfaces of the dispersion particles 5 and the adsorption particles 50 with polymeric material, and the magnitude of the repelling force can be adjusted by controlling the density, molecular amount and solubility to the liquid phase dispersion medium 6 of the polymeric material.

It is noted that, in accordance with the present embodiment, the dispersion particles 5 are not substantially charged, and are uniformly dispersed in the liquid phase dispersion medium 6.

A task of dispersing the adsorption particles 50 and the dispersion particles 5 in the liquid-phase dispersion medium 6 in manufacturing can be performed by using one or a combination of two or more of, for example, a paint shaker method, a ball mill method, a media mill method, an ultrasonic dispersion method and a stirrer dispersion method.

A liquid that exhibits low solubility to the capsule body 401 and has relatively high insulation performance is preferably used as the liquid-phase dispersion medium 6.

As the liquid-phase dispersion medium 6, it is possible to enumerate, for example, waters (such as distilled water and purified water); alcohols such as methanol; cellosolves such as methyl cellosolve; esters such as methyl acetate; ketones such as acetone; aliphatic hydrocarbons (liquid paraffins) such as pentane; alicyclic hydrocarbons such as cyclohexane; aromatic hydrocarbons such as benzene; halogenated hydrocarbons such as methylene chloride; aromatic heterocycles such as pyridine; nitrites such as acetonitrile; amides such as N,N-dimethylformamide; carboxylic salts; various kinds of oils such as silicone oil; and the like. One or more of them may be used independently or in combination.

Among them, it is preferable to use hydrocarbons each having a boiling point of 80 degree C. or higher or the silicon oil as the liquid-phase dispersion medium 6.

Further, if necessary, various kinds of additives may be added to the liquid-phase dispersion medium 6 (dispersion liquid 10). For example, it is possible to add a charge-controlling agent formed of particles of an electrolyte, a (anionic or cationic) surfactant such as alkenyl succinate, a metal soap, a resin material, a rubber material, an oil, a varnish or a compound; a dispersion agent such as a silane-based coupling agent: a lubricating agent; a stabilizing agent; and the like.

Further, when the liquid-phase dispersion medium 6 is to be colored, depending on the necessity, a pigment, such as, an anthraquinone-based pigment, an azo-based pigment, an indigoid-based pigment or the like may be dissolved in the liquid-phase dispersion medium 6.

The adsorption particles 50 are particles that are electrically charged and, are capable of moving along an inner surface of the capsule body 401 in the liquid-phase dispersion medium 6, when electric fields act thereto. Namely, the adsorption particles 50 move along the inner surface of the capsule body 401, while being adsorbed to the inner surface thereof, which will be described below.

On the other hand, the dispersion particles 5 may be particles that are electrically charged, and can electrophoretically move in the liquid-phase dispersion medium 6 when electric fields are applied thereto, or particles that are not electrically charged, as described above.

The adsorption particles 50 may be any kind insofar as they have electrical charges. Also, the dispersion particles 5 may be any kind of particles irrespective of whether they have electrical charges or not, insofar as they scatter light, or they are colored particles having a hue different from that of the adsorption particles 50. Although not particularly limited, at least one of pigment particles, resin particles and composite particles thereof may be preferably used as the particles. Use of these particles provides an advantage in that they are easy to produce, while assuring relatively easier control of electrical charges.

Also, as a pigment of which the pigment particles are made, for example, it is possible to use: a black pigment such as aniline black, carbon black or titanium black; a white pigment such as titanium oxide, antimony oxide, barium sulphate, zinc sulphide, zinc white, silicon oxide or aluminum oxide; an azo-based pigment such as monoazo, disazo or polyazo; a yellow pigment such as isoindolinone, chrome yellow, iron oxide yellow, cadmium yellow, titanium yellow or antimony; an azo-based pigment such as monoazo, disazo or polyazo; a red pigment such as quinacridone red or chrome vermilion; a blue pigment such as phthalocyanine blue, indanthrene blue. Prussian blue, ultramarine blue or cobalt blue; a green pigment such as phthalocyanine green; and the like. One or a combination of two or more of these pigments may be used.

Also, for examples, as a resin material that composes the resin particles, acryl-based resin, urethane-based resin, urea-based resin, epoxy-based resin, polystyrene, polyester and the like can be enumerated. One or a combination of two or more of these resin materials may be used.

Also, as the composite particles, for example, particles produced by coating surfaces of the pigment particles with the resin material or other pigment; particles produced by coating surfaces of the resin particles with the pigment; and particles made of a mixture obtained by mixing the pigment and the resin material in a suitable composition ratio can be enumerated.

As the particles produced by coating the surfaces of the pigment particles with the other pigment, for example, particles obtained by coating surfaces of titanium oxide particles with silicon oxide or aluminum oxide can be exemplified. These particles are preferably used as dispersion particles 5 for displaying a white color.

Also, carbon black particles, titanium black particles or particles produced by coating surfaces thereof are preferably used as adsorption particles 50 for displaying a black color.

Further, the shape of the adsorption particle 50 and the dispersion particle 5 may preferably be spherical, without any particular limitation.

The adsorption particles 50 and the dispersion particles 5 each having a relatively small size may be preferably used. More specifically, an average particle size of them is preferably in the range of about 10 nm to 3 μm, more preferably in the range of about 20 nm to 2 μm, and even more preferably in the range of about 20 nm to 800 nm. By setting the average particle size of the adsorption particles 50 and the dispersion particles 5 to the aforementioned ranges, condensation of the adsorption particles 50 and the dispersion particles 5 can be avoided, and the dispersion particles 5 can be reliably prevented from precipitating in the liquid-phase dispersion medium 6, and thus can be dispersed in the liquid-phase dispersion medium 6, thereby, as a result, favorably avoiding degradation in display quality of the display device 20 can be favorably prevented.

It is noted that, if two different types of particles are used like the present embodiment, average grain sizes of the two types of grains can be made different without a problem. According to the method of the present patent application, the display device 20 can achieve a high value of display contrast.

As shown in FIG. 1, the microcapsules 40 are arranged lengthwise and crosswise between the counter substrate 11 and the base substrate 37 so as to form a single layer (arranged side by side without overlapping in the thickness direction), and arranged in the full thickness of the microcapsule-containing layer 400.

While two microcapsules 40 are aligned with one electrode 3 in the illustrated construction, for example, without being limited thereto, one microcapsule may be aligned with one electrode 3, or three or more may be aligned with one electrode 3.

Also, in the illustrated construction, the microcapsules 40 are kept in a generally spherical shape without being compressed (pressed) in an up-and-down direction, even though they are sandwiched and held by the adhesive agent layer 8 and the base portion 31 between the counter substrate 11 and the base substrate 37. The capsule body (the shell) 401 serving as the wall portion (a wall structure) for defining a space filled with the dispersion liquid 10 (i.e., arranged with a scattering body or a colored body) is formed into a spherical shell shape (a shell defining a spherical space).

In other words, the inner surface of the capsule body 401 is formed of a curved concave surface extending (continuously provided) between the electrodes 3 and the electrode 34. This means that substantially no planar surface extending parallel to the electrodes 3 and the electrode 34 exists in the inner surface of the capsule body 401. This makes it possible for the adsorption particles 50 to smoothly and reliably move along the inner surface of the capsule body 401.

It is noted that the microcapsules 40 are not limited to the spherical shape, but may be formed into, e.g., a generally ellipsoidal shape or other shapes. In other words, the capsule body 401 is not limited to the spherical shape, but may be formed into, e.g., an ellipsoidal shell shape (a shell defining an ellipsoidal space) or the like.

The capsule body 401 is electrically charged with an opposite polarity to the adsorption particles 50. Therefore, the adsorption particles 50 are adsorbed to the inner surface of the capsule body 401 by an attractive force due to an interaction between the adsorption particles 50 and the capsule body 401, in other words, by an attractive force which amounts to a sum (a resultant force) of an electrostatic force and a van der Waals force between the adsorption particles 50 and the capsule body 401.

As shown in FIG. 2, the adsorption particles 50 are adsorbed to the inner surface of the capsule body 401 and kept stationary in a specified position, and the dispersion particles 5 are dispersed in the liquid-phase dispersion medium 6, when no electrical voltage is applied across the electrodes 3 and the electrode 34.

Next, when an electrical voltage is applied across the electrodes 3 and the electrode 34 (i.e., when a potential difference is generated between the electrodes 3 and the electrode 34), electric fields are generated between the electrodes 3 and the electrode 34, whereby the adsorption particles 50 are moved toward one of the electrodes along the inner surface of the capsule body 401 under the action of the electric fields while being adsorbed to the inner surface of the capsule body 401, and the dispersion particles 5 retains a state of being dispersed in the liquid-phase dispersion medium 6. When the voltage application is stopped, the adsorption particles 50 cease to move, and stop in a specified position while being adsorbed to the inner surface of the capsule body 401, and the dispersion particles 5 maintain a state of being dispersed in the liquid-phase dispersion medium 6.

More specifically, for example, when the adsorption particles 50 are negatively charged, and the capsule body 401 is positively charged, and if an electrical voltage is applied between the electrodes 3 and the electrode 34 in a manner that the electrodes 3 have a positive potential with respect to the electrode 34, the adsorption particles 50 move along the inner surface of the capsule body 401 toward the side of the electrodes 3 (to the opposite side to the display surface), while maintaining a state of being adsorbed to the inner surface.

If an electrical voltage is applied between the electrodes 3 and the electrode 34 in a manner that the electrodes 3 have a negative potential with respect to the electrode 34, the adsorption particles 50 move along the inner surface of the capsule body 401 toward the side of the electrode 34 (to the side of the display surface), while maintaining a state of being adsorbed to the inner surface.

In this case, the position of the adsorption particles 50 can be adjusted by applying a pulsed voltage (a pulse voltage) across the electrodes 3 and the electrode 34, namely by regulating one or both of magnitude (a voltage value) and a time (an application time) of the electrical voltage applied across the electrodes 3 and the electrode 34. Therefore, as viewed from the side of the display surface (the upper side in FIG. 2), the ratio (S2/S1) of an area (S2) of a portion of the dispersion particles 5 and the liquid-phase dispersion medium 6 (a liquid) within the capsule body 401 covered by the adsorption particles 50 to the entire area (S1) of the dispersion particles 5 and the liquid-phase dispersion medium 6 (a liquid) within the capsule body 401 (see FIG. 6) is adjusted. By this, the amount of light (brightness) of reflected light on the microcapsules 40 can be changed. It is noted that the area (S1) and the area (S2) are areas projected onto a plane parallel with the base portion 2 (the base substrate 12), respectively.

Here, although the present embodiment pertains to a full-color display device, it is also possible, in white and black display, to display not only the white color and the black color, but also an arbitrary intermediate tone (an intermediate color) between the white color and the black color, i.e., a gray color of arbitrary gradation (brightness). In other words, it is possible to continuously change the displayed color between the white color and the black color.

For example, as shown in FIG. 2, when the adsorption particles 50 are located (gathered) on the side of the electrodes 3, in other words, when the adsorption particles 50 are located in a lower hemisphere (a hemisphere on the side of the electrodes 3) of the capsule body 401, such that, as viewed from the side of the display surface, the adsorption particles 50 do not cover the dispersion particles 5 and the liquid-phase dispersion medium 6 (a liquid) within the capsule body 401, the ratio (S2/S1) becomes to be 0, and the displayed color becomes to be white. In other words, almost all (most) of light incident on the microcapsules 40 is scattered by the dispersion particles 5, whereby the white color is seen when viewed at the display device 20 from the side of the display surface thereof.

It is noted that, in the case of displaying the white color and in the case of displaying a specified color by means of the microcapsules 40 of the second fourth microcapsule-containing layers 400b 400d, to be described later, the adsorption particles 50 in the microcapsules 40 of the first microcapsule containing layer 400a are located on the side of the electrodes 3, as shown in FIG. 2.

Also, when the adsorption particles 50 are located on the side of the electrode 34, in other words, when the adsorption particles 50 are located in an upper hemisphere (a hemisphere on the side of the electrode 34) of the capsule body 401, such that, as viewed from the side of the display surface, the adsorption particles 50 entirely cover the dispersion particles 5 and the liquid-phase dispersion medium 6 (a liquid) within the capsule body 401, the ratio (S2/S1) becomes to be 1, and the displayed color becomes to be black. In other words, almost all (most) of light incident on the microcapsules 40 is absorbed by the adsorption particles 50, whereby the black color (the color of the adsorption particles 50) is seen when viewed at the display device 20 from the side of the display surface thereof.

Furthermore, when the adsorption particles 50 are located between the electrodes 3 and the electrode 34, in other words, when the adsorption particles 50 are circularly distributed extending across the upper hemisphere and the lower hemisphere of the capsule body 401, and when viewed from the side of the display surface, if the adsorption particles :50 circularly cover an outer circumferential side (a portion) of the dispersion particles 5 and the liquid-phase dispersion medium 6 (a liquid) within the capsule body 401, the ratio (S2/S1) has a predetermined value greater than 0 and smaller than 1, and the displayed color becomes to be a gray color with a specified gradation. In other words, a portion of light incident upon the microcapsule 40 is scattered by the dispersion particles 5, and the remaining portion thereof is absorbed by the adsorption particles 50, whereby a gray-color with a specified gradation level can be seen, as viewed at the display device 20 from the side of the display surface.

Although there is no particular limitation in controlling the display device 20, the display device 20 may preferably be controlled in the following manner. For example, the state that the adsorption particles 50 are positioned on the side of the electrodes 3, in other words, the state that the white color is displayed, or the state that the adsorption particles 50 are positioned on the side of the electrode 34, in other words, the state that the black color is displayed, may be set as an initial state (a reference state). When a specified intermediate tone is to be displayed, it is preferred that the initial state is first set, and then the pulse voltage may be applied across the electrodes 3 and the electrode 34. The reason for this is that it is possible to reliably set the initial state by, e.g., applying an electrical voltage across the electrodes 3 and the electrode 34 for a sufficient time (namely, there is no need to finely adjust magnitude and an application time of the electrical voltage which is applied to restore the initial state), and that it is possible to reliably display the target intermediate tone by applying the pulse voltage in the initial state.

As another control method, it may also be preferred to have a construction to apply a pulse voltage required in changing a current display state that an intermediate tone is displayed into a display state that a target intermediate tone is to be displayed. The reason for this is that the display device 20 is capable of reliably displaying the intermediate tone, and therefore, even if the current display state is successively changed into a state that a target intermediate tone is to be displayed, without restoring the initial state, the target intermediate tone can be reliably displayed.

It is noted that the voltage to be applied across the electrodes 3 and the electrode 34 is not limited to a single pulse voltage, but may be, for example, a plurality of pulse voltages having the same polarity, a plurality of pulse voltages with alternating polarities (an AC voltage), or the like.

Also, when the dispersion particles 5 are charged with an opposite polarity to the adsorption particles 50, and when a voltage is applied across the electrodes 3 and the electrode 34, the dispersion particles 5 electrophoretically move toward an electrode on the opposite side of the electrode toward which the adsorption particles 50 move. But when the application of the voltage is stopped, the dispersion particles 5 are dispersed again in the liquid-phase dispersion medium 6, which exhibits a function similar to the case where the dispersion particles 5 are not charged.

Also, as shown in FIG. 3, the display device 20 is constructed to ensure that the attractive force (f₂ in FIG. 3) due to the interaction between the adsorption particles 50 and the capsule body 401 is greater than the electrostatic force (f₁ in FIG. 3) acting on the adsorption particles 50 due to the electric fields generated between the electrodes 3 and the electrode 34. The attractive force (f₂) amounts to the sum (the resultant force) of the electrostatic force and the van der Waals force due to the interaction between the adsorption particles 50 and the capsule body 401. The task of making the attractive force (f₂) due to the interaction between the adsorption particles 50 and the capsule body 401 greater than the electrostatic force (f₁) acting on the adsorption particles 50 due to the electric fields generated can be accomplished by suitably setting, for example, a charge amount and charge density of the respective parts, or magnitude of the electrical voltage applied across the electrodes 3 and the electrode 34.

Therefore, when the electrical voltage is applied across the electrodes 3 and the electrode 34 and when the electric fields generated therebetween act on the adsorption particles 50, the sum (f₃ in FIG. 3) of the electrostatic force (f₁) and the attractive force (f₂) acts in a direction as shown in FIG. 3. This makes it possible to prevent the adsorption particles 50 from moving away from the capsule body 401, which ensures that the adsorption particles 50 are reliably moved along the inner surface of the capsule body 401 while being adsorbed to the inner surface of the capsule body 40.

The phenomenon that the adsorption particles 50 are moved along the inner surface of the capsule body 401 while being adsorbed to the inner surface is quite complex, when observed on a microscopic level, as will be described below.

More specifically, a relationship (the attractive force, etc.) between the adsorption particles 50 and the capsule body 401 is significantly complex. The interaction between the adsorption particles 50 and the capsule body 401 can be explained using a potential curve illustrated in FIG. 4. In this case, a valley of potential, as illustrated in FIG. 4, is created when summing up the attractive force between the adsorption particles 50 and the capsule body 401 (the sum of the van der Waals force and the electrostatic force) and a repulsive force (steric hindrance caused by polymer chains and osmotic pressure).

When a distance between a surface of each of the adsorption particles 50 and the inner surface of the capsule body 401 is Z₀ in FIG. 4, the adsorption particles 50 are adsorbed to the inner surface of the capsule body 401 in a position in which the surface of each of the adsorption particles 50 is spaced a distance Z₀ from the inner surface of the capsule body 401. The distance Z₀ is on the order of nanometers and, in effect, they are in a state in which their polymer chains are in contact with each other.

If electric fields are generated between the electrodes 3 and the electrode 34 in this state, the adsorption particles 50 would readily move away from the inner surface of the capsule body 401 because a slope of the potential curve is zero in the position spaced apart by the distance Z₀.

However, as the adsorption particles 50 approach a position spaced apart by a distance Z₁, the slope of the potential curve becomes greater, thereby allowing an increased attractive force to act on the adsorption particles 50. Thus, the adsorption particles 50 are no longer able to move away from the inner surface of the capsule body 401 and, instead, are moved toward the inner surface of the capsule body 401.

As a result, if the electric fields are generated between the electrodes 3 and the electrode 34, the adsorption particles 50 move on the inner surface of the capsule body 401, along the inner surface. At this time, each of the adsorption particles 50 moves along the inner surface of the capsule body 401 while slightly changing the distance between the surface thereof and the inner surface of the capsule body 401 (while slightly bouncing up and down) as illustrated in FIG. 5.

In this embodiment, the capsule body (the shell) 401, in which the dispersion liquid 10 and the adsorption particles 50 are encapsulated, includes a first capsule layer (a first layer) 402 and a second capsule layer (a second layer) 403 arranged outside the first capsule layer 402, as shown in FIG. 1.

The first capsule layer 402 and the second capsule layer 403 are respectively formed into a spherical shell shape (a shell-like shape). An outer surface of the first capsule layer 402 is covered with the second capsule layer 403. This makes it possible to synergistically impart characteristics of the first capsule layer 402 and the second capsule layer 403 to the capsule body 401.

In the capsule body 401, one of the first capsule layer 402 and the second capsule layer 403 may be electrically charged or both of them may be electrically charged.

As a constituent material of each of the first capsule layer 402 and the second capsule layer 403, for example, a material containing gum such as gum Arabic or the like, a composite material of gum Arabic and gelatin, various kinds of resin materials such as urethane-based resin, acryl-based resin, epoxy-based resin, melamine-based resin, urea-based resin, polyamide and polyether, and the like can be enumerated. One or more of them can be used independently or in combination.

A cross-linking agent may be added to the resin of which each of the first capsule layer 402 and the second capsule layer 403 is made, so as to form a cross-linked (three-dimensionally cross-linked) structure therein. This makes it possible to increase the strength of each of the first capsule layer 402 and the second capsule layer 403. As a result, it is possible to more securely prevent the microcapsules 40 from being collapsed.

Here, charging or non-charging, the charge amount, charge density and polarity of each of the first capsule layer 402 and the second capsule layer 403 are also affected by the liquid-phase dispersion medium 6. Therefore, the constituent material (the combination of components of the constituent material), a mixing ratio thereof, and various forming conditions of each of the first capsule layer 402 and the second capsule layer 403 are suitably set depending on the liquid-phase dispersion medium 6 used, whereby each of them is electrically charged with a specified polarity, while adjusting the charge amount and the charge density thereof. In this case, additives such as a charging agent and the like may be added.

Further, it is preferred that the first capsule layer 402 and the second capsule layer 403 are chemically bonded together in their interfacial surfaces. This makes it possible to reliably prevent any separation between the first capsule layer 402 and the second capsule layer 403 even when pressure is applied between the circuit board 22 and the display sheet 21. As a result, it is possible to reliably prevent the microcapsules 40 from being collapsed due to the pressure applied at the time of bonding the first microcapsule-containing layer 400a and the circuit board 22 together or due to an impact and a pressing force applied when the microcapsules 40 are used and stored as the display device.

The thickness of the capsule body 401 (the sum of a thickness of the first capsule layer 402 and a thickness of the second capsule layer 403 in this embodiment) is not particularly limited to any specific value, but may preferably be in the range of 0.1˜5 μm, more preferably in the range of 0.1 to 4 μm, and even more preferably in the range of 0.1 to 3 μm in a wet state. If the thickness of the capsule body 401 is too small, there is a fear that sufficient capsule strength may not be obtained depending on a combination of the constituent materials of the first capsule layer 402 and the second capsule layer 403. In contrast, if the thickness of the capsule body 401 is too great, there is a fear that the transparency may be reduced depending on a combination of the constituent materials of the first capsule layer 402 and the second capsule layer 403, which may lead to a reduction in the display contrast of the display device.

The capsule body 401, although being structured to have two layers consisting of the first capsule layer 402 and the second capsule layer 403 in this embodiment, may have a single layer construction or a multiple layer construction with three or more layers, without being limited to this two-layer construction.

As for a particle size of the capsule body 401, a volume-average particle size thereof is preferably in the range of 10 to 100 μm, and more preferably in the range of 20 to 80 μm. If the particle size of the capsule body 401 is within such a range, it is possible to form the microcapsule-containing layer 400 with increased dimensional accuracy.

If the particle size of the capsule body 401 is far smaller than the lower limit value noted above, there is a fear that both surfaces of the first microcapsule-containing layer 400a may be filled with the microcapsules 40, thereby reducing the display contrast.

In contrast, if the particle size of the capsule body 401 is far greater than the upper limit value noted above, there is a fear that the gaps between the microcapsules 40 become wider, consequently reducing the display contrast.

It is preferred that the microcapsules 40 are formed such that their sizes (particle sizes) are generally uniform (or equal). More specifically, a coefficient of variation (a CV value) of the particle size is preferably in the range of 0.5˜25%, and more preferably in the range of 0.5˜20%. This ensures that the microcapsules 40 are arranged uniformly, thereby preventing or reducing occurrence of display variance in the display device 20, and superior display performance can be exhibited.

As will be set forth later, the display device 20 is generally manufactured by interposing the adhesive agent layer 8 between the circuit board 22 and the display sheet 21 and bonding them together in that state. The bonding is performed in a state in which the circuit board 22 and the display sheet 21 are kept in close proximity to each other. Pressure is applied between the circuit board 22 and the display sheet 21 in order to bring them into close proximity to each other. Further, when the display device 20 of the present invention is incorporated into an electronic paper that requires flexibility, similar flexural deformation occurs in the display device 20 each time the electronic paper is flexed, and at each of such occasions, pressure is applied between the circuit board 22 and the display sheet 21.

The microcapsules 40 have strength great enough to keep a spherical shape between the electrode 34 and the adhesive agent layer 8 even when the pressure is applied between the circuit board 22 and the display sheet 21. This makes it possible to increase both of pressure resistance and bleed resistance of the microcapsules 40, thereby ensuring that the display device 20 can be stably operated for an extended period of time. The term “pressure resistance of the microcapsules 40” refers to a property with which the microcapsules 40 resist the pressure applied thereto without being crushed. The term “bleed resistance of the microcapsules 40” refers to a property with which the liquid-phase dispersion liquid 6 and the like contained in the microcapsules 40 is kept against dissipation to the outside.

Next, the microcapsules 40 of the second˜fourth microcapsule-containing layers 400b˜400d will be described, but their differences with respect to the microcapsules 40 of the first microcapsule-containing layer 400a will be mainly described.

The adsorption particles (electrically charged particles) 50 are adsorbed to an inner surface of the capsule body 401 of each of the microcapsules 40 of the second˜fourth microcapsule-containing layers 400b˜400d. In other words, the adsorption particles 50 are electrically charged with a specified polarity and the capsule body 401 is electrically charged with an opposite polarity to the adsorption particles 50 such that the adsorption particles 50 are adsorbed to the inner surface of the capsule body 401.

The adsorption particles 50 may include one or more kinds of particles, and particles that are colored (colored particles) may preferably be used.

In the present embodiment, one kind of colored particles is used as the adsorption particles 50 of the microcapsules 40 of each of the second˜fourth microcapsule-containing layers 400b˜400d, respectively. In this case, the adsorption particles 50 of the microcapsules 40 of the second microcapsule-containing layer 400b have a hue different from that of the adsorption particles 50 of the microcapsules 40 of the first microcapsule-containing layer 400a. Further, the adsorption particles 50 of the microcapsules 40 of the third microcapsule-containing layer 400c have a hue different from those of the adsorption particles 50 of the microcapsules 40 of the first and second microcapsule-containing layer 400a and 400b. Also, the adsorption particles 50 of the microcapsules 40 of the fourth microcapsule-containing layer 400d have a hue different from those of the adsorption particles 50 of the microcapsules 40 of any of the first˜third microcapsule-containing layer 400a˜400c. In other words, the hues of the adsorption particles 50 of the microcapsules 40 in the first fourth microcapsule-containing layers 400a˜400d are different from one another.

More specifically, in accordance with the present embodiment, as the adsorption particles 50, colored particles that display magenta (M) are used in the microcapsules 40 in the second microcapsule-containing layer 400b, colored particles that display cyan (C) are used in the microcapsules 40 in the third microcapsule-containing layer 400c, and the colored particles that display yellow (Y) are used in the microcapsules 40 in the fourth microcapsule-containing layer 400d. This makes it possible to provide full color display.

It is noted that, for performing full color display, for example, colored particles that display red (R), colored particles that display green (G), and colored particles that display blue (B) may be used as the adsorption particles 50 of the microcapsules 40 of the second˜fourth microcapsule-containing layers 400b˜400d.

A liquid as a transparent medium which is substantially transparent, i.e., a liquid 15 containing no particle in this embodiment, is encapsulated (or filled) in the capsule body 401. As the liquid 15, a liquid similar to the liquid-phase dispersion medium 6 described above may be used.

In this regard, the term “substantially transparent” means that, when filled in the capsule body 401, the liquid 15 has visible light transmittance of 80% or more.

It is possible to use, e.g., a liquid containing particles or a gas such as air or the like in place of the liquid 15. In the case of using the gas, the pressure within the capsule body 401 is not particularly limited to a specific value, but may be nearly vacuum (or substantially vacuum) within the capsule body 401.

In the microcapsules 40 of the second microcapsule-containing layer 400b, the adsorption particles 50 can be in a state in which the adsorption particles 50 are positioned on the side of the electrode 34 shown in FIG. 7, or in a state in which the adsorption particles 50 are positioned between the electrode 34 and the electrode 35, and distributed in a belt-like form across the upper hemisphere and the lower hemisphere of the capsule body 401, as shown in FIG. 2. Also, they are allowed to be freely moveable between these positions. In other words, the adsorption particles 50 serve as a shutter for changing the microcapsules 40 between a state in which the color of the adsorption particles 50 is reflected to the displayed color and a state in which the color of the adsorption particles 50 is not reflected in the displayed color.

As shown in FIG. 7, when the adsorption particles 50 are positioned on the side of the electrode 34, in other words, when the adsorption particles 50 are positioned in the lower hemisphere (a hemisphere on the side of the electrode 34) of the capsule body 401, the color of the adsorption particles 50 is reflected in the display color.

Also, as shown in FIG. 2, when the adsorption particles 50 are located between the electrode 34 and the electrode 35, in other words, when the adsorption particles 50 are distributed in a belt-like form extending across the upper hemisphere and the lower hemisphere of the capsule body 401, almost all (most) of the light incident on the microcapsule 40 passes through the adsorption particles 50 of the microcapsule 40, and the color of the adsorption particles is not reflected in the displayed color. This position of the adsorption particles 50 is referred to as a “non-reflected position.”

Also, by moving the adsorption particles 50 to a specified position between the position of the electrode 34 side shown in FIG. 7 and the non-reflected position shown in FIG. 2, the degree (rate) of reflecting the color of the adsorption particles 50 can be adjusted, whereby a great variety of colors can be displayed.

The microcapsules 40 of the third and fourth microcapsule-containing layers 400c and 400d serve in a similar manner, respectively.

It is noted that the display device 20 may be constructed in a manner that, for example, the electrode 4 is grounded (earthed), and +A volt and −A volt may be selectively applied to the electrodes 3, 34˜36, respectively. This makes it possible to selectively apply a positive voltage or a negative voltage across the electrodes 3 and 34, across the electrodes 34 and 35, across the electrodes 35 and 36, and across the electrodes 36 and 4, respectively.

2. Operating Method of Display Device

Such a display device 20 is operated as follows.

Hereinafter, a method of operating (functioning) the display device 20 will be described with reference to FIG. 6 and FIG. 7. The following description will be made based on a representative instance wherein the adsorption particles 50 of the microcapsules 40 of the first˜fourth microcapsule-containing layers 400a˜400d are negatively charged, with the capsule body 401 being charged positively, and wherein a state that the adsorption particles 50 of the first microcapsule-containing layer 400a are positioned on the side of the first electrodes 3, the adsorption particles 50 of the second microcapsule-containing layer 400b are positioned on the side of the electrode 34, the adsorption particles 50 of the third microcapsule-containing layer 400c are positioned on the side of the electrode 35, and the adsorption particles 50 of the fourth microcapsule-containing layer 400d are positioned on the side of the electrode 36, is set as an initial state.

First, when displaying the white color, an electrical voltage is applied across the electrodes 3 and the electrode 34 so that the electrodes 3 can be in a positive potential with respect to the electrode 34, for the first microcapsule-containing layer 400a. For assurance, the electrical voltage is preferably applied for a time sufficient to allow the adsorption particles 50 to move from the electrode 4 to the electrodes 3.

As a consequence, the adsorption particles 50, while being adsorbed to the inner surface of the capsule body 401, move along the inner surface thereof toward the electrodes 3, and stop on the side of the electrodes 3. On the other hand, the dispersion particles 5 maintain its state of being dispersed in the liquid-phase dispersion medium 6.

Further, for the second˜fourth microcapsule-containing layers 400b˜400d, an electrical voltage is applied across the electrode 34 and the electrode 35 so that the electrode 34 can be in a negative potential with respect to the electrode 35, an electrical voltage is applied across the electrode 35 and the electrode 36 so that the electrode 35 can be in a negative potential with respect to the electrode 36, and an electrical voltage is applied across the electrode 36 and the electrode 4 so that the electrode 35 can be in a negative potential with respect to the electrode 4. In this case, a calibration curve (for example, a calculation formula, a table or the like) representing correlation between positions of the adsorption particles 50 and time durations of voltage application, which has been experimentally obtained in advance, is stored in an unshown memory device. A control device not illustrated obtains a voltage application time duration required for moving the adsorption particles 50 to a non-reflecting position based on the calibration curve, and applies an electrical voltage for the voltage application time.

As a consequence, the adsorption particles 50 of the second˜fourth microcapsule-containing layers 400b˜400d, while being adsorbed to inner surfaces of the capsule bodies 401, move along the inner surfaces thereof toward the electrodes 35, 36 and 4, and stop at non-reflecting positions, respectively.

As a consequence, the white color is displayed. Also, when displaying the black color, an electrical voltage is applied across the electrodes 3 and the electrode 34 so that the electrodes 3 can be in a negative potential with respect to the electrode 34. For assurance, the electrical voltage is preferably applied for a time sufficient to allow the adsorption particles 50 to move from the electrodes 3 to the electrodes 34.

As a consequence, the adsorption particles 50, while being adsorbed to the inner surface of the capsule body 401, move along the inner surface thereof toward the electrode 34, and stop on the side of the electrode 34. On the other hand, the dispersion particles 5 maintain their state of being dispersed in the liquid-phase dispersion medium 6.

As a consequence, the black color is displayed.

When displaying a gray color that is an intermediate tone, the first microcapsule-containing layer 400a is restored to the initial state as described above and, thereafter, an electrical voltage is applied across the electrodes 3 and the electrode 34 so that the electrodes 3 can be in a negative potential with respect to the electrode 34. In this case, a calibration curve (for example, a calculation formula, a table, etc.) representing correlation between gray colors with different gradations (respective intermediate tones) and voltage application time durations, which has been experimentally obtained in advance, is stored in a storage device not illustrated. A control device not illustrated obtains a voltage application time duration required to obtain a gray color with a target gradation (a target intermediate tone), and applies an electrical voltage for the voltage application time duration.

As a consequence, the adsorption particles 50 of the first microcapsule-containing layer 400a, while being adsorbed to the inner surface of the capsule body 401, move along the inner surface thereof toward the electrode 34, and stop on the side of the electrode 34. On the other hand, the dispersion particles 5 maintain their state of being dispersed in the liquid-phase dispersion medium 6. As a consequence, as viewed from the side of the display surface, this creates a state in which an outer peripheral side of the dispersion particles 5 and the liquid-phase dispersion medium 6 (a liquid) in the capsule body 401 is covered annularly by the adsorption particles 50, in other words, the ratio (S2/S1) assumes a specified value that is greater than 0 but smaller than 1, thereby displaying the gray color with the target gradation.

For example, in a second display example from the left in FIG. 6, a relatively bright (near white) gray color is displayed, and in a third display example from the left in FIG. 6, a relatively dark (near black) gray color is displayed.

It goes without saying that, for the first microcapsule-containing layer 400a, the voltage application can be performed without restoring the initial state.

Further, when displaying a specified color by means of the microcapsules 40 of he second˜fourth microcapsule-containing layers 400b˜400d, the first fourth microcapsule-containing layers 400a˜400d are once reset to the initial state as described above. Thereafter, among the second˜fourth microcapsule-containing layers 400b˜400d, each microcapsule-containing layer which includes the adsorption particles 50 with a color that will not be reflected in a display color is impressed with an electrical voltage across its pair of electrodes, so that the lower electrode has a negative potential with respect to the upper electrode, thereby moving the adsorption particles 50 to the non-reflecting position. In this case, as described above, the control device not illustrated obtains a voltage application time duration for moving the adsorption particles 50 to the non reflection position, and applies an electrical voltage for that time duration.

For example, as shown in FIG. 7, when the adsorption particles 50 in the third microcapsule-containing layer 400c alone are moved to the non-reflecting position, a mixed color of magenta of the second microcapsule-containing layer 400a and yellow of the fourth microcapsule-containing layer 400d is displayed.

Also, in this case, by moving the adsorption particles 50 of the second microcapsule-containing layer 400b to a specified position between the position of the electrode 34 and the position of the non-reflecting position, and moving the adsorption particles 50 of the fourth microcapsule-containing layer 400b to a specified position between the position of the electrode 36 and the position of the non-reflecting position, the degree (rate) of reflecting the color of the adsorption particles 50 can be adjusted, whereby a great variety of colors can be displayed.

For the first˜fourth microcapsule-containing layers 400a˜400d, it goes without saying that a voltage application can be performed without recovering the initial state, respectively.

In this manner, it becomes possible to provide full color display, and desired information (images) can be displayed through displaying each of the colors or combining them.

3. Method of Manufacturing Display Device

The display device 20 can be manufactured in the following manner.

Hereinafter, a method of manufacturing the display device 20 will be described with reference to FIG. 8 through FIG. 10. The method of manufacturing the display device 20 illustrated in FIG. 8 to FIG. 10 includes a microcapsule production step [A1] for producing the microcapsules 40 of the first˜fourth microcapsule-containing layers 400a˜400d, a microcapsule dispersion liquid preparation step [A2] for preparing a microcapsule dispersion liquid containing the microcapsules 40 of the first˜fourth microcapsule-containing layers 400a˜400d, first˜fourth microcapsule-containing layer formation steps [A3] for forming the first˜fourth microcapsule-containing layers 400a˜400d containing the microcapsules 40 on one surfaces of the base substrates 31, 32, 33 and 12, respectively, a lamination step [A4], and a sealing step [A5] for forming the sealing portion 7.

It is noted that the microcapsule production step [A1], the microcapsule dispersion liquid preparation step [A2] and the microcapsule-containing layer formation steps [A3] constitute a microcapsule-containing layer forming step in the method of manufacturing the display device in accordance with the present invention.

A step for producing the base substrate 12 to be prepared in the microcapsule-containing layer formation step [A3] includes an electrode formation step for forming the electrode 4 on the lower surface of the base portion 2. A step for producing the substrate 39 to be prepared in the bonding step [A4] includes a first electrode forming step for forming the electrode 36 on the upper surface of the base portion 33. A step for producing the circuit substrate 38 to be prepared in the bonding step [A4] includes a first electrode forming step for forming the electrode 35 on the upper surface of the base portion 32. A step for producing the circuit substrate 37 to be prepared in the bonding step [A4] includes a first electrode forming step for forming the electrode 34 on the upper surface of the base portion 31. A step for producing the circuit substrate 22 to be prepared in the bonding step [A4] includes an electrode forming step for forming the electrodes 3 on the upper surface of the base portion 1. These electrode forming steps constitute an electrode formation step in the method of manufacturing the display device according to the present invention. Hereinbelow, each of the steps will be described.

### [A1] Step of Producing Microcapsule 40

This step will be described with reference to the microcapsules 40 of the first microcapsule-containing layer 400a, as a representative.

### [A1-1] Formation of First Capsule Layer 402

First, microcapsules that encapsulate the dispersion liquid 10 and the adsorption particles 50 in the first capsule layer 402 are obtained. For the sake of convenience in description, these microcapsules will be referred hereafter to as “microcapsule precursors.”

The first capsule layer 402 can be formed by various kinds of a microcapsule production method, using a controlled liquid composed of the dispersion liquid 10 and the adsorption particles 50 as a core material.

The microcapsule production method (a method of encapsulating the controlled liquid into the first capsule layer 402) is not particularly limited to a specific type, but for example, various microcapsule production methods can be used, including an interfacial polymerization method, an in-situ polymerization method, a phase separation method (or a coacervation method), an interfacial sedimentation method and a spray drying method. These microcapsule production methods may be suitably selected depending on the constituent material or the like of the first capsule layer 402.

Here, the first capsule layer 402 is not electrically charged during the process of forming the first capsule layer 402. Instead, a step of electrically charging the capsule body 401 is performed thereafter. If the first capsule layer 402 is electrically charged during the process of forming the first capsule layer 402, the adsorption particles 50 will be adsorbed to and embedded in (or fixed to) the first capsule layer 402 due to the electrostatic force therebetween. This problem can be reliably avoided because the first capsule layer 402 is not electrically charged.

The microcapsule precursors having a uniform size can be obtained by using, e.g., a sieving method, a filtering method or a specific gravity difference sorting method.

### [A1-2] Formation of Second Capsule Layer 403

Next, the second capsule layer 403 is formed on the outer surface of the microcapsule precursor (the first capsule layer 402) obtained in the step [A1-1], thereby obtaining the microcapsules 40 which contain the dispersion liquid 10 and the adsorption particles 50 therein.

The second capsule layer 403 can be formed by, e.g., gradually adding a resin prepolymer to a capsule dispersion liquid in which the microcapsule precursor is dispersed in an aqueous medium and causing a condensation reaction to the prepolymer adsorbed to the outer surfaces of the microcapsule precursors. By this, the second capsule layer 403 is formed on the outer surface of the microcapsule precursors, thus producing the microcapsules 40 containing the dispersion liquid 10 and the adsorption particles 50.

When forming the second capsule layer 403, the capsule body 401 (one or both of the first capsule layer 402 and the second capsule layer 403) is electrically charged with the opposite polarity to the adsorption particles 50 (in the charging step). In this case, as mentioned earlier, the constituent material (the combination of components of the constituent material), the mixing ratio thereof and the various forming conditions of each of the first capsule layer 402 and the second capsule layer 403 are suitably set depending on the liquid-phase dispersion medium 6 to be used, thereby electrically charging them with the opposite polarity to the adsorption particles 50, while adjusting the charge amount and the charge density thereof. Through this charging step, the adsorption particles 50 are adsorbed to the inner surface of the capsule body 401 due to the electrostatic force therebetween.

It is noted that the microcapsule 40 having a uniform size can be obtained by using, e.g., a sieving method, a filtering method or a specific gravity difference sorting method.

In this manner, in the microcapsule production step [A1] of the manufacturing method of this embodiment, the charging step for electrically charging the capsule body 401 with the opposite polarity to the adsorption particles 50 is performed after forming the first capsule layer 402 that constitutes an inner surface portion (a portion) of the capsule body 401.

It is noted that, for the second˜fourth microcapsule-containing layers 400b˜400d, the dispersion liquid 10 described above may be changed to the liquid 15.

### [A2] Microcapsule Dispersion Liquid Preparation Step

Next, the binder 41 is prepared, and then this binder 41 is mixed with the microcapsules 40 produced in the step [A1] to thereby obtain a microcapsule dispersion liquid. This step is conducted for the microcapsules 40 of each of the first˜fourth microcapsule-containing layers 400a˜400d.

A mixing ratio of the binder 41 and the microcapsules 40 produced in the step [A1] is such that the microcapsules 40 are preferably in the range of 100 to 500 parts by weight, and more preferably in the range of 200 to 450 parts by weight, with respect to 100 parts by weight of the binder 41.

An amount of the microcapsules 40 contained in the microcapsule dispersion liquid is preferably in the range of about 30˜60 wt %, and more preferably in the range of about 40˜60 wt %.

If the amount of the microcapsules 40 is set to fall within the above-noted range, there is provided a great advantage in that the microcapsules 40 can be moved (or rearranged) within the microcapsule-containing layer 400 in such a manner as not to overlap one another in a thickness direction thereof (in a single layer).

[A3] Step of Forming Microcapsule-Containing Layer 400

Next, the base substrate 12 is prepared as illustrated in FIG. 8 (a). Then, the microcapsule dispersion liquid for the fourth microcapsule-containing layer 400d prepared in the step [A2] is applied on the base substrate 12 on the side of the electrode 4, as illustrated in FIG. 8 (b).

A method of coating the microcapsule dispersion liquid is not particularly limited to a specific type, but various kinds of coating methods, such as, for example, an applicator method, a bar coater method, a die coater method, an air knife coater method, a kiss coater method and a gravure coater method can be used.

Depending on necessity, the microcapsule dispersion liquid is coated so that a thickness (a quantity) thereof becomes uniform across the base substrate 12 at any portion thereof, preferably coated so that the microcapsules 40 can be arranged side by side (in a single layer) without overlapping one another in a thickness direction.

The operation can be performed by, e.g., sweeping the microcapsules 40 with a squeegee (a plate-like jig) 100 passing above the base substrate 12 as illustrated in FIG. 8 (c).

Thus, the fourth microcapsule-containing layer 400d is formed on the base substrate 12 on the side of the electrode 4, as illustrated in FIG. 8 (d).

In a similar manner, the base substrates 37˜39 are prepared, the first microcapsule-containing layer 400a is formed on the base substrate 37 on the opposite side of the electrode 34, the second microcapsule-containing layer 400b is formed on the base substrate 38 on the opposite side of the electrode 35, and the third microcapsule-containing layer 400c is formed on the base substrate 39 on the opposite side of the electrode 36.

### [A4] Lamination Step

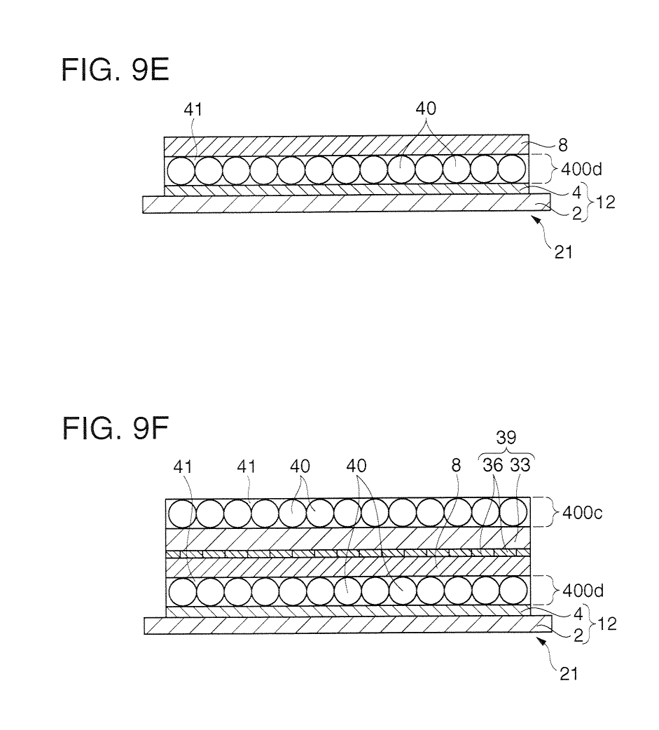

Next, as illustrated in FIG. 9 (e), the adhesive agent layer 8 is formed on the fourth microcapsule-containing layer 400d.

This step can be performed by, e.g., arranging an adhesive agent layer 8 in a sheet form on the microcapsule-containing layer 400d by an overcoat method, a transfer method or the like.

Next, as illustrated in FIG. 9 (f), the base substrate 39 formed with the third microcapsule-containing layer 400c is laminated on the adhesive agent layer 8 in a manner that the electrode 36 comes in contact with the adhesive agent layer 8. By so doing, these two are bonded together through the adhesive agent layer 8.

Similarly, an adhesive agent layer 8 is formed on the third microcapsule-containing layer 400c, and the base substrate 38 formed with the second microcapsule-containing layer 400b is laminated on the adhesive agent layer 8 in a manner that the electrode 35 comes in contact with the adhesive agent layer 8. By so doing, these two are bonded together through the adhesive agent layer 8.

Next, in a similar manner, an adhesive agent layer 8 is formed on the second microcapsule-containing layer 400b, and the base substrate 37 formed with the first microcapsule-containing layer 400a is laminated on the adhesive agent layer 8 in a manner that the electrode 34 comes in contact with the adhesive agent layer 8. By so doing, these two are bonded together through the adhesive agent layer 8, and the display sheet 21 is obtained.

Next, in a similar manner, an adhesive agent layer 8 is formed on the first microcapsule-containing layer 400a, and the circuit board 22 prepared separately is laminated on the adhesive agent layer 8 so that the electrodes 3 can come into contact with the adhesive agent layer 8. By so doing, these two, i.e., the display sheet 21 and the circuit board 22 are bonded together through the adhesive agent layer 8, as illustrated in FIG. 10 (g).

At this time, an arrangement density of the microcapsules 40 in the first fourth microcapsule-containing layers 400a˜400d can be made uniform due to weight of each of the members or by pressing the base substrate 11 and the base substrate 12 toward each other (by reducing the thickness of each of the microcapsule-containing layers).

When bringing the base substrate 11 and the base substrate 12 closer to each other, the magnitude of the pressure to be applied thereto is normally set to about 0.05˜0.6 MPa. However, in this display device 20, it is ensured that the microcapsules 40 contained in the first˜fourth microcapsule-containing layers 400a˜400d can be kept in a generally spherical shape without being compressed (pressed) in an up-and-down direction thereof, even when the first˜fourth microcapsule-containing layers 400a˜400d are pinched in a state that the pressure of the above noted magnitude is applied across the base substrate 11 and the base substrate 12. As a result, collapse of the microcapsules 40, and dissipation of the dispersion liquid 10, the adsorption particles 50 and the liquid 15, which would otherwise be caused by the pressure applied between the base substrate 11 and the base substrate 12, can be securely prevented. Furthermore, the adsorption particles 50 can smoothly and reliably move along the inner surface of the capsule body 401.

### [A5] Sealing Step

Next, as illustrated in FIG. 10 (h), the sealing portion 7 is formed along the edges of the display sheet 21 and the circuit board 22.

This can be formed by supplying a material for forming the sealing portion 7 between the display sheet 21 (the base portion 2) and the circuit board 22 (the base portion 1) along the edges thereof, using, for example, a dispenser, and then solidifying or curing the material.

The display device 20 is obtained through the steps described above.

The adhesive agent layer 8 may be omitted, and the respective members may be bonded together by using other methods. As one of such other methods, for example, the binder 41 may be used to bond them together.

As described above, according to the display device 20, full color display can be readily and reliably performed. In particular, the adsorption particles 50 are normally adsorbed to any region on the inner surface of the capsule body 401, and move along the inner surface while being adsorbed to the inner surface of the capsule body 401, and the adsorption particles 50 and the dispersion particles 5 would not be adsorbed to one another, such that each of the colors can be readily and reliably obtained.

Also, since the adsorption particles 50 are adsorbed to the inner surface of the capsule body 401 even when the application of the electrical voltage between the pair of electrodes is stopped, it is possible to reliably maintain the individual colors. This ensures that the display content (the image) is stably maintained with no deterioration of its display state even when the voltage application is stopped.

Because the adsorption particles 50 are adsorbed to the inner surface of the capsule body 401 in the first microcapsule-containing layer 400a, and further the adsorption particles 50 and the dispersion particles 5 would not be adsorbed to one another, it is possible to obtain high display contrast and to improve chromatic purity.

Also, while being adsorbed to the inner surface of the capsule body 401, the adsorption particles 50 are moved along the inner surface thereof, it is possible to reliably move the adsorption particles :50 with relatively weak electric fields, whereby the power consumption can be reduced.

According to the conventional electrophoretic type display devices, full color display is performed by using microcapsules for displaying red color containing red particles, microcapsules for displaying green color containing green particles, and microcapsules for displaying blue containing blue particles. In the conventional display devices, it is necessary to arrange the microcapsules for displaying the respective colors on corresponding electrodes on a common plane, and their positioning is difficult. In contrast, the present display device 20 does not need such a positioning. The reason for this is because, in this display device 20, the first˜fourth microcapsule-containing layers 400a˜400d are laminated, and each four of the microcapsules 40 in the lamination direction (the up-down direction in FIG. 1) constitute a minimum unit, whereby full color display can be performed with the four microcapsules 40, and each of the microcapsules 40 arranged in the lamination direction positioned on each of the electrodes constitute each pixel. This makes it possible to readily and reliably manufacture a full color display device 20.

Also, this display device 20 is a so-called microcapsule type and therefore can be manufactured more readily and reliably than a so-called microcup type display device.

In accordance with the present invention, a dedicated pair of electrodes may be provided in one, two, three or the entirety of the first˜fourth microcapsule-containing layers 400a˜400d.

Also, in the present invention, adsorption particles with a hue different from that of the adsorption particles 50 may be used as the dispersion particles 5.

### Second Embodiment

Hereinafter, a second embodiment will be described, with emphasis placed on points differing from the first embodiment, but description on the same matters shall be omitted.

In a method of manufacturing a display device 20 of the second embodiment, when forming the capsule bodies 401 of the microcapsules 40 of the first˜fourth microcapsule-containing layers 400a˜400d, the capsule bodies 401 are not electrically charged. Only after the capsule bodies 401 have been entirely formed, in other words, after the microcapsule production step [A1] has been completed, a charging step for electrically charging the capsule bodies 401 with the opposite polarity to the adsorption particles 50 through the binder 41 is performed in the microcapsule dispersion liquid preparation step [A2].

In this case, a specified amount of positive or negative charging agent may be added to the binder 41 depending on the polarity of the adsorption particles 50. This makes it possible to adjust the charge amount and the charge density of the capsule body 401 while electrically charging the capsule body 401 with the opposite polarity to the adsorption particles 50. In this regard, it is to be noted that the binder 41 may be or may not be electrically charged.

According to this display device 20, the same effects as those of the first embodiment described above can be obtained.

### Third Embodiment

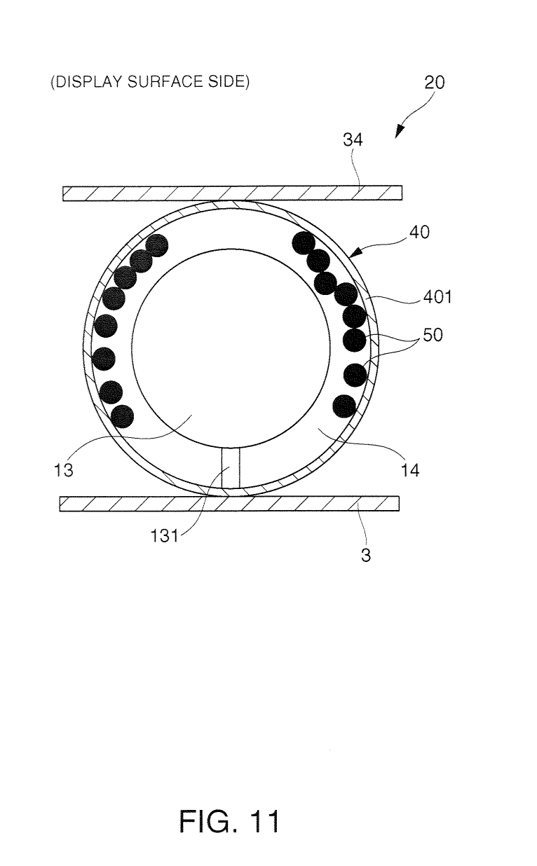

FIG. 11 is a vertical cross-sectional view schematically showing a microcapsule in the first microcapsule-containing layer in the third embodiment of a display device according to the present invention.

In the following description, the upper side in FIG. 11 will be referred to as “upper,” and the lower side as “lower,” for the sake of convenience in description. Also, in FIG. 11, illustration of the capsule body 401 is simplified to show the same in one layer.

Hereinafter, the third embodiment will be described, with emphasis placed on points differing from the first embodiment, but description on the same matters shall be omitted.

In a display device 20 of the third embodiment, the microcapsule 40 in the first microcapsule-containing layer 400a includes a structure 13 serving as a scattering body or a coloring body in a space within the capsule body 401, being spaced a specified distance from the inner surface of the capsule body 401.

The structure 13 of the present embodiment has an external configuration that is generally similar to the inner configuration of the capsule body 401, and is affixed to the capsule body 401 at a specified portion (a portion on the opposite side of the display surface in the illustrated composition) by a supporting portion 131. The adsorption particles 50 are positioned in a space (a gap space) 14 between the outer surface of the structure 13 and the inner surface of the capsule body 401, and move along the inner surface of the capsule body 401, while being adsorbed to the inner surface. It is noted that the supporting section 131 has, for example, a stick configuration that is very thin compared to the capsule body 401 and the structure 13, and would not obstruct movements of the adsorption particles 50.

The structure 13 may be composed of anything that has a function to scatter light or has a hue different from that of the adsorption particles 50 without any particular limitation, and for example, a shell containing one or two of particles (powder), liquid and gas, a solid body (a bulk body) and the like may be used.

It is noted that the space 14 may be filled with a gas, such as, air, or may be in a near vacuum state (substantially vacuum).

According to this display device 20, effects similar to those of the first embodiment described above can be obtained.

### Fourth Embodiment

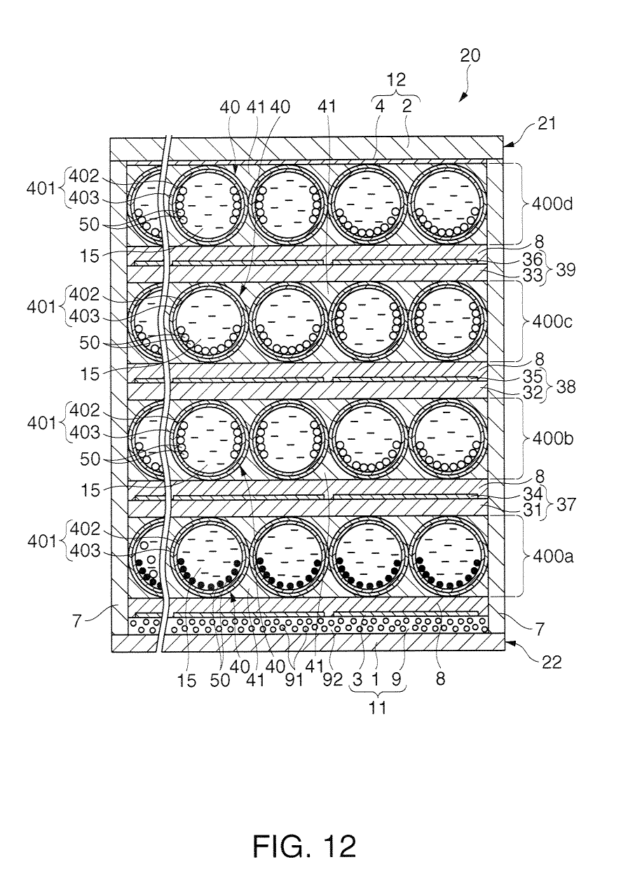

FIG. 12 is a vertical cross-sectional view schematically showing the fourth embodiment of a display device according to the present invention.

In the following description, the upper side in FIG. 12 will be referred to as “upper,” and the lower side as “lower.” for the sake of convenience in description.

Hereinafter, the fourth embodiment will be described, with emphasis placed on points differing from the first embodiment, but description on the same matters shall be omitted.

As illustrated in FIG. 12, in a display device 20 of the fourth embodiment, the microcapsules 40 of the first microcapsule-containing layer 400a of the display sheet (front plane) 21 use a liquid 15 (which does not contain dispersion particles 5 within the capsule body 401) in place of the dispersion liquid 10, like the second˜fourth microcapsule-containing layers 400b˜400c.

It is noted that the adhesive agent layers 8 provided between the base portions 31˜33 and 2 and the electrodes 3, 34˜36 and 4, between the base substrate 37 and the second microcapsule-containing layer 400b, between the base substrate 38 and the third microcapsule-containing layer 400c, and between the base substrate 39 and the fourth microcapsule-containing layer 400d, are optically permeable, in other words, substantially transparent (clear and colorless, clear and colored, or translucent). This makes it possible to easily recognize, through visual observation, a status of the adsorption particles 50, i.e., information (images) displayed by the display device 20.

Also, the circuit board 22 includes a counter substrate 11, which has a plate-like base portion 1, a plate-like reflector 9 provided on an upper surface of the base portion 1, and a plurality of electrodes 3 formed on an upper surface of the reflector 9, and circuits (not shown) provided in the counter substrate 11 (on the base portion 1), the circuits including switching elements such as TFTs and the like.

The reflector 9 is provided on an opposite side of the base substrate 12 of the microcapsule-containing layer 400 (on the opposite side of the display surface), in other words, between the electrodes 3 and the base portion 1. This makes it possible to shorten a distance between the electrodes 3 and the electrode 4 as compared to a case where the electrodes 3 would be provided between the reflector 9 and the base portion 1. Therefore, it is possible to generate stronger electric fields and to allow them to act on the adsorption particles 50 of the microcapsules 40 of the first microcapsule-containing layer 400a.

The reflector 9 serves to diffusely reflect light. (incident light). In this embodiment, the reflector 9 is in a sheet-like shape (a plate-like shape) and is formed from a light-transmitting solid phase medium 92 and a plurality of particles 91 capable of scattering the light embedded in the medium 92 (wherein, the particles 91 are filled in gaps). The particles 92 are uniformly dispersed in the medium 92.

It is preferred that the particles 91 have a refraction index greater than that of the medium 92. This ensures that the light incident on the reflector 9 is scattered by the particles 91 and, therefore, diffusely reflected from the reflector 9.

The particles 91 are not particularly limited to a specific type, and may be any kind of particles insofar as they can scatter the light. For example, pigment particles, resin particles and composite particles thereof may be used. Examples of pigments forming the pigment particles include white pigments such as titanium oxide, antimony oxide and the like. Among them, titanium oxide is preferably used.

A shape of the particles 91 may preferably be spherical, but is not particularly limited thereto. It is preferred that particles 91 each having a relatively small size are used. More specifically, an average particle size of the particles 91 is preferably in the range of about 10˜500 nm, and more preferably in the range of about 20˜300 nm.

The reflector 9 may be either flexible or rigid, but may preferably be one having flexibility. Use of the reflector 9 having flexibility makes it possible to provide a flexible display device 20, in other words, a display device 20 useful in constructing, for example, an electronic paper.

A reflection plate (a second reflector) having an upper surface being a mirror surface not shown in the drawings may be provided on a lower surface of the reflector 9, i.e., between the reflector 9 and the base portion 1. This ensures that, even when a part of the incident light passes through the reflector 9, this light can be reflected by the reflection plate, which makes it possible to improve efficiency with which the incident light is used.

As the medium 92 of the reflector 9, a liquid phase medium may also be used, without any limitation to a solid phase medium. In this case, for example, a housing for containing the medium 92 is to be provided. It is preferred that specific gravity of the particles 92 is generally equal to that of the medium 92. This makes it possible to reliably obtain a state in which the particles 91 are uniformly dispersed in the medium 92.

The reflector 9 is not limited to the structure as described above, but may be in any structure insofar as it has a function of diffusely reflecting the light. For example, a metal plate (a reflection plate) having fine surface irregularities (a coarse surface) may be used.

The reflector 9 and the electrodes 3 may have a positional relationship vertically inverted from the illustrated construction. In other words, the electrodes 3 may be provided on the upper surface of the base portion 1, and the reflector 9 may be provided on the upper surfaces of the first electrodes 3. In this instance, the first electrodes 3 may be opaque.

Also, the reflector 9 may be constructed to have the same function as the base portion 1, in other words, may be constructed to have a function of supporting and protecting the individual members. In this case, it may be possible to omit the base portion 1.

While the reflector 9 is continuously formed (as a single body) in the illustrated construction, the reflector 9 may be formed of a plurality of unit reflectors, without any limitation to the above. In this case, either one microcapsule 40 or a plurality of microcapsules 40 may be arranged in alignment with one unit reflector.

In this display device 20, when displaying the black color, the adsorption particles of the microcapsules 40 in the first microcapsule-containing layer 400a are positioned to the side of the electrodes 3, as shown in FIG. 12.

By so doing, almost all (a major part) of light incident on the microcapsules 40 of the first microcapsule-containing layer 400a is absorbed by the adsorption particles 50, whereby the black color is seen when viewed at the display device 20 from the side of the display surface thereof.

When displaying the white color, and when displaying a specified color by means of the microcapsules 40 of the second˜fourth microcapsule-containing layers 400b˜400d, the adsorption particles 50 of the microcapsules 40 of the first microcapsule-containing layer 400a are positioned in non-reflecting positions.

For example, when displaying the white color, the adsorption particles 50 of the microcapsules 40 of the first˜fourth microcapsule-containing layers 400a 400d are positioned in non-reflecting positions, respectively. By this, almost all (a major portion) of light incident on the microcapsules 40 of the first˜fourth microcapsule-containing layers 400a˜400d passes through the microcapsules 40 and arrives at the reflector 9 where light is scattered by the particles 91, whereby, as a result, the light is diffusely reflected from the reflector 9. Therefore, the white color is seen as viewed at the display device 20 from the display surface side thereof. In other words, the reflector 9 has a function similar to that of a plane light source.

Further, for example, when displaying a mixed color of yellow and magenta, the adsorption particles 50 of the microcapsules 40 of the second and fourth microcapsule-containing layers 400b and 400d are positioned on the side of the electrode 35, and the adsorption particles 50 of the microcapsules 40 of the first and the third microcapsule-containing layers 400a and 400c are positioned on the non-reflecting positions, respectively (see the microcapsules 40 on the right side in FIG. 12).

According to this display device 20, effects similar to those of the first embodiment described above can be obtained.

Also, in this display device 20, among the light diffusedly reflected by the reflector 9, light having a great reflection angle (light reflected toward a neighboring microcapsule 40) is absorbed by the adsorption particles 50, and therefore is prevented from affecting the neighboring pixel.

It is noted that, in the present invention, the method of manufacturing the display device is not limited to the manufacturing method described above. Hereinafter, other embodiments of the method of manufacturing the display device are described.

According to this embodiment, the steps including the step A3 and the step A4 for forming microcapsule-containing layers in the manufacturing method described above, and a step of laminating the microcapsule-containing layers are concurrently conducted. More specifically, the following is conducted.

### [B1]

On a base substrate having patterned first pixel electrodes, a first microcapsule-containing layer is formed. Fabrication of the first microcapsule-containing layer may be conducted in the same manner as the step A3 of the manufacturing method described above. Switching elements such as TFTs for energizing (driving) the first pixel electrodes are provided in the base substrate.

### [B2]

A first common electrode is formed by a coating step on the first microcapsule-containing layer. This first common electrode may be formed by coating, for example. ITO coating liquid, PEDOT, carbon nanotube dispersion liquid or the like.

Also, prior to forming the first common electrode, a flattening layer or the like may be formed on the first microcapsule-containing layer. The flattening layer is provided with a conductivity (which is almost near insulating) that creates an optimum surface.

### [B3]

An insulating material in a liquid state is supplied onto the first common electrode and is dried, thereby forming a flattening layer that is electrically insulating (an insulating flattening layer).

For example, an aperture may be formed in the insulating flattening layer. When forming an aperture in the insulating flattening layer, a photosensitive liquid insulating material may be supplied onto the first common electrode, dried and then exposed to light.

### [B4]

Patterned second pixel electrodes are formed on the insulating flattening layer. The second pixel electrodes may be formed by using, for example, a photolithography method, a printing method or the like. Also, switching elements such as TFTs electrically conducted to the second pixel electrodes are formed.

### [B5]

A second microcapsule-containing layer is formed on the second pixel electrodes formed in the step B4, in a manner similar to the step B1 described above. By this, formation of the second microcapsule-containing layer and lamination of the first microcapsule-containing layer and the second microcapsule-containing layer are performed at the same time.

Positions of the microcapsules of the first microcapsule-containing layer and the microcapsules of the second microcapsule-containing layer may preferably coincide with one another, but may not necessarily coincide with one another.

### [B6]

Like the step B2 described above, a second common electrode is formed by a coating step on the second microcapsule-containing layer.

Thus, the display device having two microcapsule-containing layers can be obtained.

Furthermore, when manufacturing a display device having three or more microcapsule-containing layers, the steps B3˜B6 described above are repeated a necessary number of times.

It is noted that switching elements such as TFTs to be electrically connective to the pixel electrodes in each of the microcapsule-containing layers may be provided all together in the base substrate where the first microcapsule-containing layer is formed, and the corresponding pixel electrodes and switching elements may be connected to one another through apertures or the like formed in the insulating flattening layer in the step B3.

Hereinabove, the description has been made as to a case where, on the base substrate, the first pixel electrodes/the first microcapsule-containing layer/the first common electrode/the insulating flattening layer/the second pixel electrodes/the second microcapsule-containing layer are laminated in this order. However, the present invention is not limited to the above, and for example, the common electrode for one microcapsule-containing layer among two adjacent microcapsule-containing layers and the pixel electrodes for the other microcapsule-containing layer may be mutually shared.

In other words, on the base substrate, the first pixel electrodes/the first microcapsule-containing layer/the second pixel electrodes/the second microcapsule-containing layer/third pixel electrodes may be laminated in this order. In this case, for example, when applying electric fields to the first microcapsule-containing layer, an electrical voltage is applied across the first pixel electrodes and the second pixel electrodes. Then, in a manner not to affect the adsorption particles of the second microcapsule-containing layer, an electrical voltage to be applied to the third pixel electrodes is controlled (by, for example, maintaining the third pixel electrodes at high impedance or at the same potential as that of the second pixel electrodes so as to prevent electric fields from extending to the second microcapsule-containing layer).

### <Electronic Apparatus>

The display device 20 described above can be incorporated in a variety of electronic apparatuses. Hereinafter, electronic apparatuses in accordance with the present invention equipped with the display device 20 will be described.

### <<Electronic Paper>>

First, description will be made regarding an embodiment in which the electronic apparatus of the present invention is applied to an electronic paper.

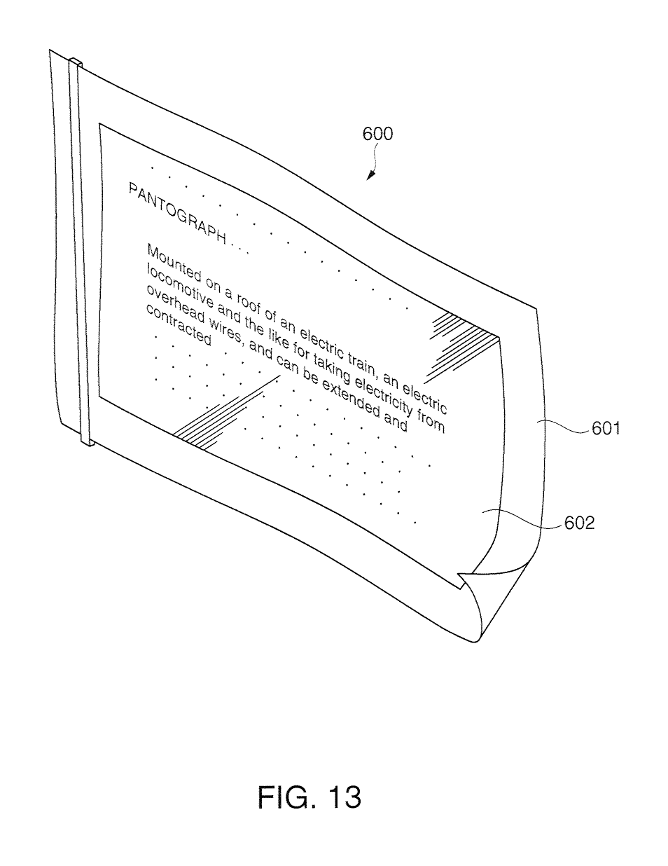

FIG. 13 is a perspective view showing an embodiment in which the electronic apparatus according to the present invention is applied to an electronic paper.

An electronic paper 600 shown in FIG. 13 includes a main body 601 formed of a rewritable sheet having the same texture and flexibility as that of a paper sheet, and a display unit 602.

In the electronic paper 600, the display unit 602 is formed from the display device 20 described above.

### <<Display>>

Next, description will be made regarding an embodiment in which the electronic apparatus of the present invention is applied to a display apparatus.

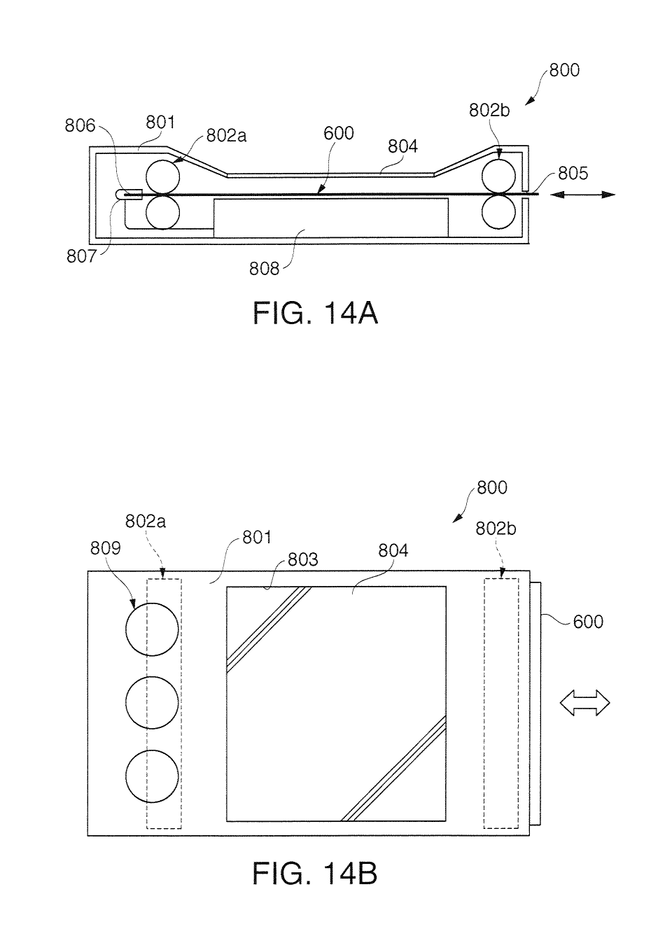

FIGS. 14 are views showing an embodiment in which the electronic apparatus according to the present invention is applied to a display apparatus. In FIGS. 14, (a) is a cross-sectional view, and (b) is a plan view.

A display (display device) 800 shown in FIGS. 14 includes a main body portion 801 and an electronic paper 600 detachably attached to the main body portion 801. The electronic paper 600 is of the same configuration as set forth above, i.e., the same configuration as shown in FIG. 14.

The main body portion 801 is provided on its one lateral side (the right side in FIG. 14 (a)) with an insertion slot 805 through which the electronic paper 600 can be inserted, and is provided with two pairs of conveying rollers 802a and 802b inside. When the electronic paper 600 is inserted into the main body portion 801 through the insertion slot 805, the electronic paper 600 is held within the main body portion 801 in a state in which it is gripped by means of the pairs of conveying rollers 802a and 802b.

A rectangular opening 803 is formed on a display surface side (the front side in FIG. 14 (b)) of the main body portion 801 and a transparent glass plate 804 is fitted to the rectangular opening 803. This allows the electronic paper 600 held within the main body portion 801 to be visually recognized from the outside of the main body portion 801. In other words, the display apparatus 800 has a display surface that allows the electronic paper 600 held within the main body portion 801 to be visually recognized through the transparent glass plate 804.

Also, a terminal portion 806 is formed in an insertion direction leading edge portion (the left side in FIGS. 14) of the electronic paper 600. Provided within the main body portion 801 is a socket 807 that makes contact with the terminal portion 806 when the electronic paper 600 is placed within the main body portion 801. A controller 808 and an operation part 809 are electrically connected to the socket 807.

In the display apparatus 800 described above, the electronic paper 600 is removably fitted to the main body portion 801 and is portable in a state that it is removed from the main body portion 801.

Furthermore, the electronic paper 600 of the display apparatus 800 is formed from the display device 20 described above.

It is noted that the electronic apparatus of the present invention is not limited to such applications as described above. For example, it is applicable to a television set, a viewfinder type or monitor viewing type video tape recorder, a car navigation system, a pager, an electronic notebook, an electronic calculator, an electronic newspaper, a word processor, a personal computer, a workstation, a TV phone, a POS terminal, a device provided with a touch panel and the like. The display device 20 of the present invention can be applied to display parts of these various kinds of electronic apparatuses described above.

While the present invention has been described hereinabove based on the illustrated embodiments, the present invention is not limited thereto. The construction of each part may be replaced by an arbitrary construction having the same function. Furthermore, other arbitrary constituents or steps may be added to the present invention.

In addition, the present invention may be embodied by combining two or more arbitrary constituents (features) of the respective embodiments described above.

Also, according to the present invention, the number of layers of the adsorption particle-containing layers (microcapsule-containing layers) is not limited to 4 layers, but may be 2 layers, 3 layers, 5 layers or more.

While a pair of electrodes is provided in a mutually facing relationship in the foregoing embodiments, the present invention is not limited thereto, but may be applied to, for example, a construction in which a pair of electrodes is provided on the same substrate.

Also, while a plurality of substrates is provided in a mutually facing relationship in the foregoing embodiments, the present invention is not limited thereto, but may be applied to, for example, a construction having a single substrate.

Further, while the microcapsules are arranged so as not to straddle the neighboring pixel electrodes (electrodes) in the foregoing embodiments, the present invention is not limited thereto. Alternatively, the microcapsules may be arranged to straddle, for example, two neighboring pixel electrodes or three or more neighboring pixel electrodes. Also, these arrangements may be used in combination.

Also, according to the embodiments described above, the microcapsules are arranged in a manner that their positions in the lateral direction in the figure (the direction in which the microcapsules are arranged) are matched (aligned) with one another among the microcapsule-containing layers (adsorption particle-containing layers). However, the present invention is not limited to the above and they can be shifted from one another.

While the foregoing embodiments are directed to a so-called microcapsule type display device, the present invention is not limited thereto, but may be applied to, for example, a display device in which an adsorption particle-containing layer including the adsorption particles is divided by partition walls, specifically, a so-called microcup type display device which includes a plurality of cell spaces (spaces) divided by the partition walls, wherein the adsorption particles are adsorbed to inner surfaces (cell space side surfaces) of the partition walls.

In the microcup type display device, it is preferred that the inner surfaces of the wall portions for defining the spaces have curved concave surfaces extending (continuously extending) between a pair of electrodes. In particular, it is preferred that the wall portions define spherical or ellipsoidal spaces.

1. A display device comprising:
a laminate portion of a plurality of laminated adsorption particle-containing layers including a first adsorption particle-containing layer having a wall portion defining a space and electrically charged adsorption particles adsorbed to an inner surface of the wall portion, and a second adsorption particle-containing layer including a wall portion defining a space and electrically charged adsorption particles adsorbed to an inner surface of the wall portion and having a hue different from that of the adsorption particles of the first adsorption particle-containing layer; and
one or more pairs of electrodes that, when applied with an electrical voltage, generate electric fields to act on the adsorption particles,
wherein an electrical voltage across the one or more pairs of electrodes, the adsorption particles of each of the absorption particle-containing layers are configured to be moved, while being adsorbed to the inner surface of the wall portion, along the inner surface.

2. A display device recited in claim 1, wherein the adsorption particles are adsorbed to the inner surface of the wall portion due to an electrostatic force.

3. A display device recited in claim 1, wherein each one pair of the electrodes are provided on each of the first absorption particle-containing layer and the second absorption particle-containing layer.

4. A display device recited in claim 3, wherein the one pair of electrodes are provided opposite to each other through the corresponding one of the adsorption particle-containing layers, and the inner surface of the wall portion has a curved concave surface extending between the one pair of electrodes.

5. A display device recited in claim 4, wherein the electrode between the first absorption particle-containing layer and the second absorption particle-containing layer is common to the first absorption particle-containing layer and the second absorption particle-containing layer.

6. A display device recited in claim 3, wherein the adsorption particles and the wall portion are charged with mutually opposite polarities, whereby the adsorption particles are adsorbed to the inner surface of the wall portion.

7. A display device recited in claim 6, wherein an attractive force due to an interaction between the adsorption particles and the wall portion including the electrostatic force therebetween is greater than an electrostatic force acting on the adsorption particles due to the electric fields generated between the pair of electrodes.

8. A display device recited in claim 1, wherein the wall portion is formed from a shell body defining the space in a spherical shape or an ellipsoidal shape, and a microcapsule is formed by encapsulating the adsorption particles in the shell body.

9. A display device recited in claim 8, wherein the shell body has a first layer and a second layer disposed outside the first layer, each being in a shell-like shape.

10. A display device recited in claim 1, wherein the first absorption particle-containing layer among the absorption particle-containing layers is located remotest from a display surface, and the first absorption particle-containing layer has a scattering body disposed in the space for scattering light.

11. A display device recited in claim 10, wherein the scattering body is a structure provided in the space, being spaced a specified distance from the inner surface of the wall portion, and the adsorption particles are positioned between the wall portion and the structure.

12. A display device recited in claim 1, wherein the first absorption particle-containing layer among the absorption particle-containing layers is located remotest from a display surface, and the first absorption particle-containing layer has a colored body disposed in the space and having a hue different from the adsorption particles.

13. A display device recited in claim 12, wherein the colored body is a structure provided in the space, being spaced a specified distance from the inner surface of the wall portion, and the adsorption particles are positioned between the wall portion and the structure.

14. A display device recited in claim 1, wherein the first absorption particle-containing layer among the absorption particle-containing layers is positioned remotest from a display surface, and comprising a reflector that diffusely reflects light to an opposite side of the display surface of the first adsorption particles containing layer,

15. A method of manufacturing a display device comprising:
a first microcapsule-containing layer formation step for producing microcapsules each encapsulating electrically charged adsorption particles in a shell, and forming a first microcapsule-containing layer containing the microcapsules;
a second microcapsule-containing layer formation step for producing microcapsules each encapsulating in a shell electrically charged adsorption particles having a hue different from that of the adsorption particles in the first microcapsule-containing layer, and forming a second microcapsule-containing layer containing the microcapsules; and
a lamination step for laminating the first microcapsule-containing layer and the second microcapsule-containing layer, and
characterized in that each of the first microcapsule-containing layer formation step and the second microcapsule-containing layer formation step comprises a charging step for electrically charging the shell with an opposite polarity to the adsorption particles after forming a portion or the entirety of the inner surface side of the shell, whereby the adsorption particles are adsorbed to the inner surface of the shell by the charging step.

16. A method of manufacturing a display device recited in claim 15, wherein the shell comprises a first layer and a second layer arranged outside the first layer, each having a shell-like shape, and the charging step is performed when forming the second layer.

17. A method of manufacturing a display device recited in claim 16, wherein, after the shell has been formed, the charging step is performed through a fixing material that makes close contact with the outer surface of each of the microcapsules to fix the microcapsules in place.

18. An electronic apparatus characterizing in having the display device recited in claim 1.
